(19) United States
(12) Patent Application Publication
(10) Pub. No.: US 2016/0371614 A1
(43) Pub. Date: Dec. 22, 2016

(54) PLATFORM FOR MANAGING RESOURCES

(71) Applicant: The CAPROCK Group, Inc., Boise, ID (US)

(72) Inventors: Matthew Richard Weatherley-White, Boise, ID (US); Mark Kenneth Gustafson, Boise, ID (US); Nicolas Michael Flores, Boise, ID (US); Jefferson Richard Jewell, Boise, ID (US)

(21) Appl. No.: 15/184,462

(22) Filed: Jun. 16, 2016

Related U.S. Application Data
(60) Provisional application No. 62/180,489, filed on Jun. 16, 2015.

(51) Int. Cl. G06Q 10/06; G06Q 40/06

(52) U.S. Cl. CPC G06Q 10/0631; G06Q 40/06

(57) ABSTRACT

A framework enables the automated and coherent analysis of the management of resources. Such resources may include impact resources. As such, the framework provides an integrated overview of various impacts of a resource portfolio, resource fund, manager of a fund, or other resource management instrument. The framework generates detailed reports at the portfolio, fund, manager, or firm levels. The reports provide an overview and a robust data set of metrics, scores, and other analytics regarding the impact of a particular resource management thesis, including at least an impact strategy score and an execution risk score. By determining a quantified and standardized measurement of the social and/or environmental benefits or impacts of various resource management instruments, the framework provides a user an aggregated overview of the various impacts at both the level of user's portfolio and the various funds, managers, or firms that the user holds within their portfolio.

### CROSS-REFERENCE TO RELATED APPLICATIONS

This application is a Utility Patent application based on a previously filed U.S. Provisional Patent Application U.S. Ser. No. 62/180,489 filed on Jun. 16, 2015, the benefit of the filing date of which is hereby claimed under 35 U.S.C. §119(e) and which is further incorporated by reference in its entirety.

### TECHNICAL FIELD

The present invention relates generally to resource management and more particularly, but not exclusively to the evaluation and reporting of resource management metrics.

### BACKGROUND

Impact Investing, a discipline that considers social and environmental factors, as well as the financial return associated with investment capital, has increased in popularity over the last several decades. In addition to seeking a positive financial return, Impact investors strategically deploy their investment capital with the intention to encourage environmental stewardship, consumer protection, human rights, social diversity, and other positive social impacts. In this way, Impact investors blend the fundamentals of both Socially Responsible Investing (SRI) and Environmental, Sustainable and Governance (ESG) investing. As such, these investors may concentrate on investment vehicles and/or investment instruments that provide capital to corporations and other organizations that seek to impact society and/or the environment in beneficial ways. Furthermore, some Impact investors may wish to avoid deploying capital in corporations or organizations that the investor believes to actively contribute to social harm.

Various metrics, taxonomies, standards, and systems, such as the Impact Reporting and Investment Standards (IRIS), Global Impact Investing Rating System (GIIRS), and the like have been developed to provide impact investors a snapshot or partial perspective of the positive impacts associated with various corporations, funds, fund managers, and the like. However, with such a diverse and disparate array of impact metrics to ponder, it is difficult for an impact investor to evaluate, in a consistent and coherent manner, each of the companies or funds that the investor is considering including in their investment portfolio. Similarly, impact investors may find difficulty in making pre- and post-investment decisions based on non-financial considerations (social and/or environmental performance) when reviewing the allocation of their investment portfolio in view of their overall impact strategy or thesis. It is for these and other concerns that the following disclosure is provided.

### BRIEF DESCRIPTION OF THE DRAWINGS

FIG. 1 is a system diagram of an environment in which at least one of the various embodiments may be practiced;

FIG. 2 shows a client device in which at least one of the various embodiments may be practiced;

FIG. 3 shows a network device in which at least one of the various embodiments may be practiced;

FIG. 4 shows a logical schematic of a system in accordance with at least one of the various embodiments;

FIG. 5 shows an overview flowchart for process that is operative for managing resources in accordance with at least one of the various embodiments;

FIG. 6 shows an overview flowchart for process that is operative for generating an impact strategy score for a resource or resource manager in accordance with at least one of the various embodiments;

FIG. 7 shows an overview flowchart for process that is operative for generating an execution risk score for a resource or resource manager in accordance with at least one of the various embodiments;

FIG. 8A shows an interface of a visual display of a portfolio impact theme and building block heat map;

FIG. 8B shows another embodiment of an interface of a visual display of a portfolio impact theme and building block heat map;

FIG. 8C shows an embodiment of a portfolio data structure that includes records with various fields, including ID, Category, Weight, Parent ID, and Customer ID;

FIG. 9 illustrates an interface providing detailed information regarding a building block within a portfolio's building block distribution;

FIG. 10 shows an interface that provides the impact theme and building block heat maps for a manager of a fund included in a portfolio under review;

FIG. 11 shows an interface that provides the Target, Scalability, and Innovation impact factor ratings, as well as the impact strategy score for a manager of a fund included in a portfolio under review;

FIG. 12 shows an interface that provides risk ratings, as well as the execution risk score for a manager of a fund included in a portfolio under review;

FIG. 13 shows an interface that provides to roadmap, milestones, and status of various milestone for a manager of a fund included in a portfolio under review;

FIG. 14 shows an interface that provides impact metrics, firm scores, and an impact rating for a manager of a fund included in a portfolio under review;

FIG. 15 shows an interface that provides a listing and a ranking of mangers of funds based on at least one of an impact strategy score, an execution risk score, or an asset class associated with the manager;

FIG. 16 shows a screen clipping of an interface of a visual display of a portfolio impact theme and building block heat map that employs relative sizes and colors to demonstrate details of the distributions;

FIG. 17 shows a screen clipping of an interface of a visual display that demonstrates an impact geography of a fund;

FIG. 18 shows a screen clipping of an interface of a visual display that demonstrates a zoomed in view of impact geography of a fund;

FIG. 19 shows a screen clipping of an interface of a visual display that demonstrates the dynamic nature of the analysis and reporting features of the various embodiments described herein;

FIG. 20 shows a screen clipping of an interface that provides a metric modal that is consistent with the various embodiments described herein;

FIG. 21A shows a screen clipping of an interface that provides a fund manager database that is consistent with the various embodiments described herein;

FIG. 21B shows a screen clipping of an interface that provides highlights and a heat map for a particular fund manager included in the fund manager database of FIG. 21A;

FIG. 21C shows a screen clipping of an interface that provides metrics reported by the particular fund manager of FIG. 21B;

FIG. 21D shows a screen clipping of an interface that provides geography information for the particular fund manager of FIG. 21B; and

FIG. 22 shows a screen clipping of an interface that provides a metrics database that is consistent with the various embodiments described herein.

### DETAILED DESCRIPTION OF THE INVENTION

Various embodiments now will be described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise. As used herein, the term “resource” may refer to virtually any asset of a finite supply. Resources may include, but are not other limited to a financial and/or currency-related assets, such as funds, collections of funds, stocks, bonds, portfolios of any such assets, and the like. A resource may include, but is not limited to capital, such as investment capital. A resource may include other vehicles, such as but not limited to grants, portfolios, and other investment instruments. A resource may include one or more investment funds, such as but not limited to an impact investing fund. A resource may include one or more investment metrics. A resource may include communication networks bandwidth assets, data storage assets, computational assets, and the like. Other non-limiting exemplary embodiments of resources may include

The term “impact investing,” as used herein, refers to the practice of strategically deploying investment capital with the intention to encourage environmental stewardship, consumer protection, human rights, social diversity, and other positive social impacts. Impact investing may include various forms of capital and investment vehicles and/or investment instruments. Impact investing may, but need not always, be financially profitable because a return on investment (ROI) may also be measured in social gains or goals. Accordingly, impact investing may include investing one or more resources.

The terms “impact theme” or “theme,” as used herein, refer to one of the plurality of top-level components that segments an impact investment, grant, fund, impact strategy, or the like into an overall framework. In various embodiments, impact investments, grants, funds, portfolios, or any other financial instrument is segmented or distributed into one or more of four (4) impact themes: Opportunity, Sustainability, Environment, and Public, based on the actual or expected social impacts of the financial instrument. In various embodiments, a Public theme includes a Secondary theme. Thus, in alternative embodiments, the term Secondary theme may be used for a Public theme. Likewise, the impact strategy, thesis, or portfolio of an investor or investing party may be segmented into similar impact themes.

In some embodiments, the four impact themes that are based on the actual or expected social impacts of the financial instrument may include: People, Resources, Climate, and Public. The People theme may be similar to, or at least include similar features and/or building blocks to the above-mentioned Opportunity theme. The Resources theme may be similar to, or at least include similar features and/or building blocks to the above-mentioned Sustainability theme. The Climate theme may be similar to, or at least include similar features and/or building blocks to the above-mentioned Environment theme.

In various embodiments, at least one of the “Opportunity” or “People” themes refers to democratizing access to goods and services that are considered crucial to a high functioning society. At least one of the “Sustainability” or “Resources” themes may refer to balancing increasing demands on regional land and natural resources with their decreasing availability. At least one of the “Environment” or “Climate” themes may refer to migrating the ecologically adverse effects of global economic development. The “Public” theme may refer to achieving social impact, indirectly, via publicly traded securities. Other embodiments include more or less than four impact themes.

Themes enable a coherent, comprehensive, and top-down analysis framework for impact investing. For instance, an investor or manger of a fund may be concentrated in one or more particular impact themes to pursue a diverse and/or diffuse approach to achieving impacts.

The terms “impact building blocks” or “building blocks” as used herein refer to subcomponents to the impact themes and are the foundational elements of a manager's or fund's impact objectives. Building blocks provide further detail regarding the manager's or fund's impact objectives or themes. Building blocks enable an analysis, evaluation, and overview of the impact intentions of a manager or fund, regardless of the actual specifics of the various approaches to the manager or fund.

Building blocks capture the critical elements associated with the corresponding impact theme and provide further direction to an impact thesis. As discussed below, sub-building blocks, under the building blocks, provide further specificity, as well as enable a manger to characterize their objectives and/or strategies via a limitless array of descriptors.

Building blocks enable the aggregation and classification of disparate approaches to impact investing. In some embodiments, sixteen (16) impact building blocks are employed, four associated with each of the four impact themes. In various embodiments, the four building blocks associated with the Opportunity theme include “Equality,” “Infrastructure,” “Services,” and “Finance.” The four building blocks associated with the Sustainability theme include “Conservation,” “Production,” “Property,” and “Rehabilitation.” The four building blocks associated with the Environment theme include “Efficiency,” “Emissions,” “Energy,” and “Waste.” The four building blocks associated with the Public theme include “Scoring,” “Engagement,” “Mandate,” and “Alignment.”

In some embodiments, the four building blocks associated with the People theme may include “Equality,” “Employment” “Access,” and “Finance.” The four building blocks associated with the Resources theme may include “Conservation,” “Production,” “Reduction,” and “Rehabilitation.” The four building blocks associated with the Climate theme may include “Efficiency,” “Emissions,” “Renewables,” and “Infrastructure.”

The application of sixteen building blocks may provide exhaustive, but yet manageable, scope of coverage and evaluation across various approaches to impact investing. However, other embodiments may include more or less than sixteen building blocks.

Briefly stated, various embodiments are directed towards an Impact Portfolio Allocation Reviewer (IPAR). An IPAR includes a framework that enables the automated and coherent analysis of the managing of one or more resources. An analyses of managing one or more resources may include, but it not otherwise limited to at least an analysis of impact investment strategies. Managing one or more resources may include providing an integrated overview of various impacts of an investment portfolio, fund, manager of a fund, financial instrument, or the like. The framework also generates detailed reports at any of the portfolio, fund, manager, or firm levels. The reports provide both an overview and a robust data set of metrics, scores, and other analytics regarding the impact of a particular investment thesis. By determining a quantified and standardized measurement of the social and/or environmental benefits or impacts of various investment instruments, IPAR provides the investor an aggregated overview of the various impacts at both the investor's portfolio level and the various funds, managers, or firms that the investor has within their portfolio.

The IPAR framework or architecture aggregates, integrates, and harmonizes disparate impact investing data and metrics into a coherent data set and a plurality of visual displays, user interfaces, and investing reports. For instance, the framework determines an overall impact strategy score for each fund or a manager of a fund that IPAR tracks and evaluates. The impact strategy score provides a single metric, based on a plurality of impact data including impact factor ratings, which summarizes the impact of the fund or manager. In various embodiments, the impact score for each fund is based on a particular investment strategy or impact thesis of a user seeking information regarding the fund, such as an impact investor.

Furthermore, the framework determines an overall execution risk score for score for each fund or a manager of a fund that IPAR tracks and evaluates. The execution risk score is based on a plurality of risk ratings determined for the fund or manager. The execution risk score provides a single metric that summarizes the execution risk of the fund or the manager. At least one of the impact strategy score or the execution risk score is dynamic and is updated and/or revisited over time as the fund or manager achieves or misses various milestones included in a roadmap for the fund or financial instrument. Although the impact strategy score and the execution risk score are determined separately and independently from one another, when viewed together, the two metrics provide an integrated and coherent overview of the past, present, and future impact performance and risk of a fund or manager.

IPAR evaluates not only market-rate investments across all asset classes, but also concessionary deployments of capital and philanthropic grants. The architecture is operative to analyze capital deployment, independent of size or expected financial return, across a plurality of asset classes. By segmenting investments into impact themes, as well as impact building blocks and sub-blocks, the framework provides the user a standardized quantification of both the impact of the investment and the execution risk of the various impact strategies. These standardized quantifications and/or measurements provide an impact investor, or user of IPAR, a direct comparison amongst a variety of investment instruments competing for the investor's capital.

Furthermore, via the impact strategy and execution risk score, IPAR provides a coherent overview of the impact and related risks that each actual or potential investment that an investor is contemplating. The IPAR framework enables a comparison of dissimilar investment and grant opportunities, and clarifies the effect of an incremental allocation for a particular user portfolio. Accordingly, a user may employ IPAR for both pre- and post-investing decision processes.

By segmenting portfolios and funds into impact theme and building block distributions, as well as providing sub-building blocks that provide specificity to the impact thesis, heat maps may generated. These heat maps visually demonstrate the areas in which the impact is relatively concentrated within a portfolio or asset class. The relative concentrations may be visually demonstrated via color-codings or relative sizes of the graphics representing the individual themes and building blocks.

IPAR houses the individual metrics captured at the fund level, as well as milestones each manager established to demonstrate execution. Various embodiments may provide, via a plurality of reports, these metrics on a quarterly and annual basis, as well updating the reports, in real or near-real time to reflect the current performance of the various funds held within the investor's portfolio.

### Illustrated Operating Environment

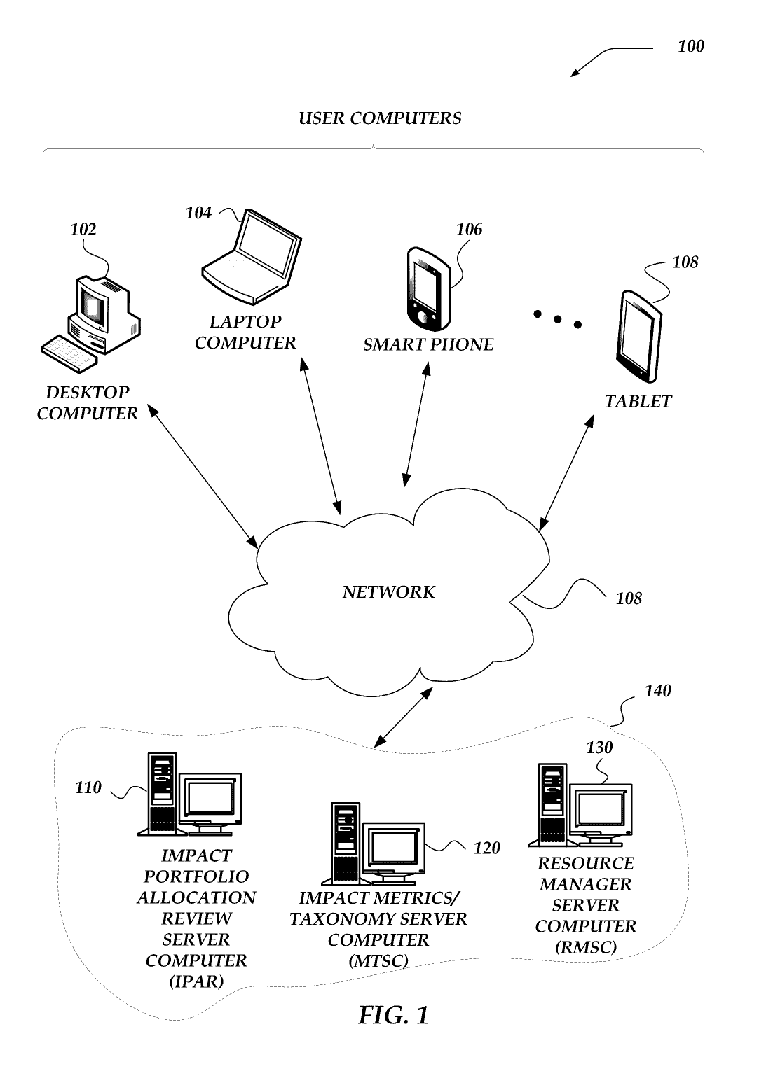

FIG. 1 shows components of one embodiment of an environment in which various embodiments of the invention may be practiced. Not all of the components may be required to practice the various embodiments, and variations in the arrangement and type of the components may be made without departing from the spirit or scope of the invention. As shown, system 100 of FIG. 1 may include impact portfolio allocation review server computer (IPAR) 110 impact metrics/taxonomy server computer (MTSC) 120, resource manager server computer (RMSC) 130, user computers 102-108, and network 108.

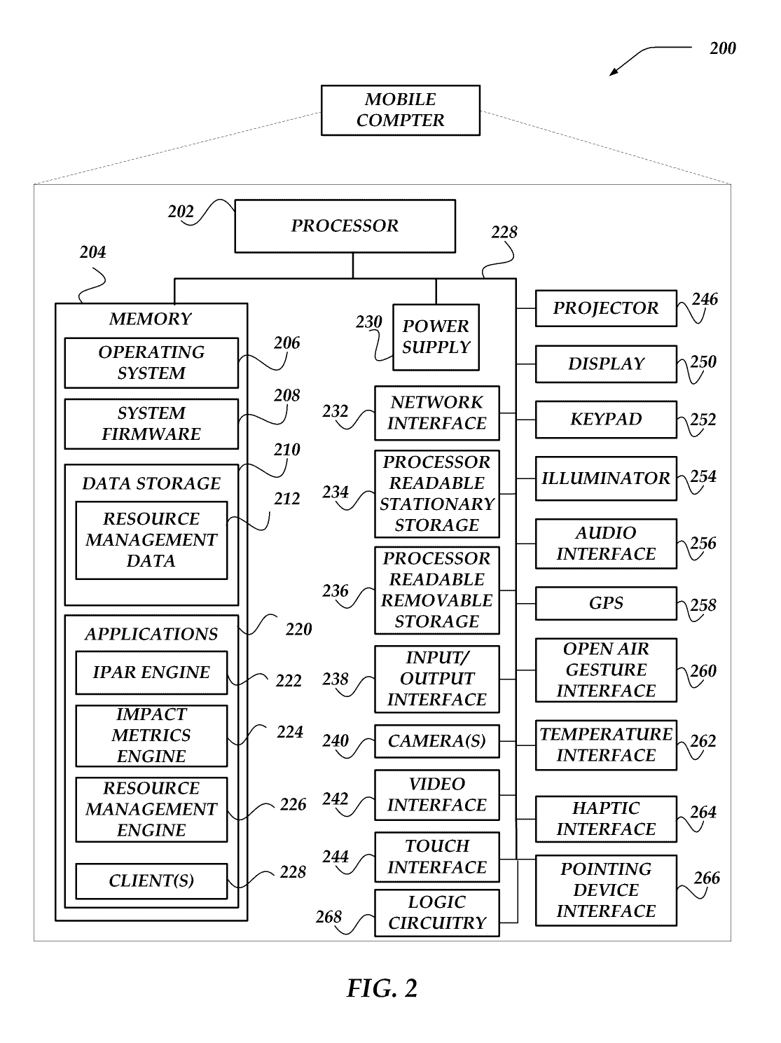

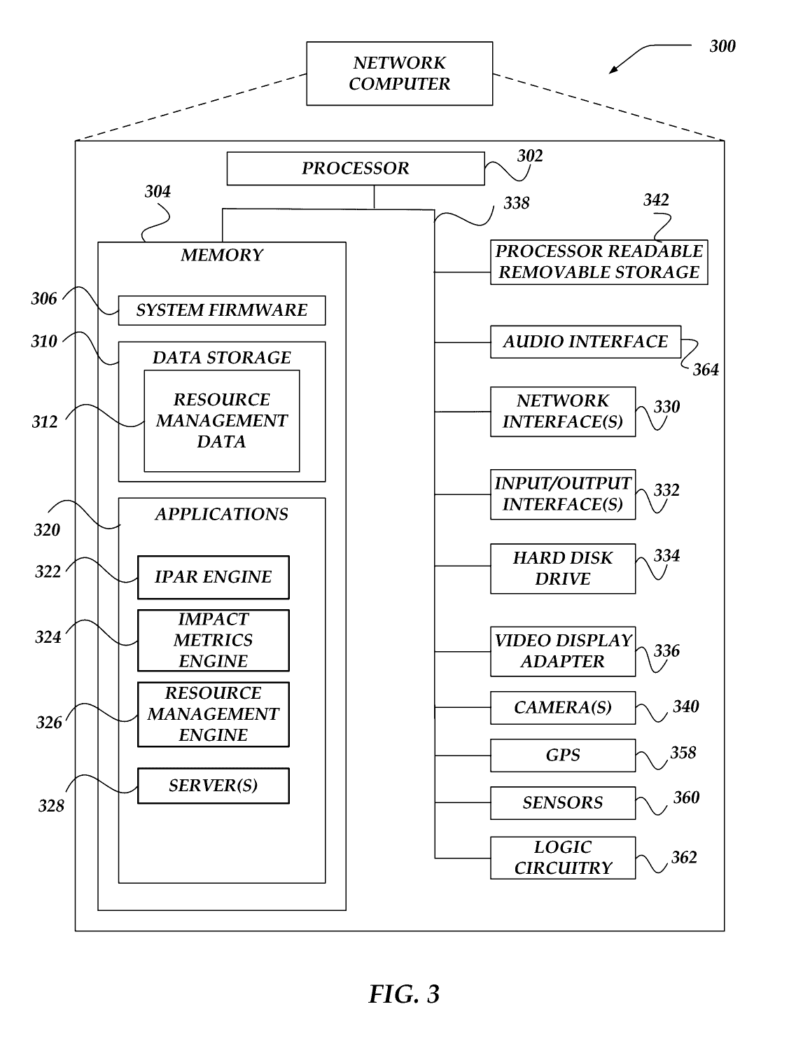

In various embodiments, system 100 includes an resource management (RM) platform 140. RM platform 140 may assistant in the management of resources, such as but not limited to impact investment funds. RM platform 140 may include one or more server computers, such as but not limited to IPAR 110, MTSC 120, and RMSC 130. RM platform 140 may include one or more instances of mobile or network computers, including but not limited to any of mobile computer 200 of FIG. 2 and/or network computer 300 of FIG. 3. In at least one embodiment, RM platform 140 includes at least one or more of the user computers 102-108. Although not shown, RM platform 140 may include one or more data storage devices, such as rack or chassis-based data storage systems. Any of the databases discussed herein may be at least partially stored in data storage devices within RM platform 140. As shown, any of the network devices, including the data storage devices included in RM platform 140 may be accessible by other network devices, via network 108. RM platform 140 may include one or more systems or sub-systems. As discussed throughout, RM platform 140 may include one or more engines and/or servers, such as but not limited to at least one of one or more IPAR servers/engines, one or more of impact metrics servers/engines, or one or more resource management servers/engines.

Various embodiments of user computers 102-108 are described in more detail below in conjunction with mobile computer 200 of FIG. 2. Furthermore, at least one embodiment of user computers 102-108 is described in more detail in conjunction with network computer 300 of FIG. 3. Briefly, in some embodiments, at least one of the user computers 102-108 may be configured to enable users to perform online activity and receive data, such as but not limited to resource management data, from RM platform 140. In various embodiments, one or more user computers 102-108 may be enabled to perform online activity via a web browser, email client, and the like. The users may receive content through the web browser or any other user interface, such as but not limited to any of the user interfaces discussed herein. In at least one of various embodiments, a user of any of user computers 102-108 may be enabled to review data, including resource management data provided by RM platform 140.

User computers 102-108 may be enabled to communicate (e.g., via a Bluetooth or other wireless technology, or via a USB cable or other wired technology) with RM platform 140. In some embodiments, at least some of user computers 102-108 may operate over a wired and/or wireless network to communicate with other computing devices, including any other of user computers 102-108 and/or any computer included in RM platform 140.

Generally, user computers 102-108 may include computing devices capable of communicating over a network to send and/or receive information, perform various online and/or offline activities, or the like. It should be recognized that embodiments described herein are not constrained by the number or type of user computers employed, and more or fewer user computers—and/or types of user computers—than what is illustrated in FIG. 1 may be employed. At least one user computer 102-108 may be a client computer or a server computer.

Devices that may operate as user computers 102-108 may include various computing devices that typically connect to a network or other computing device using a wired and/or wireless communications medium. User computers 102-108 may include mobile devices, portable computers, and/or non-portable. Examples of non-portable computers may include, but are not limited to, desktop computers 102, personal computers, multiprocessor systems, microprocessor-based or programmable electronic devices, network PCs, or the like, or integrated devices combining functionality of one or more of the preceding devices. Examples of portable computers may include, but are not limited to, laptop computer 104. Examples of mobile computers include, but are not limited to, smart phone 106, tablet computers 108, cellular telephones, display pagers, Personal Digital Assistants (PDAs), handheld computers, wearable computing devices, or the like, or integrated devices combining functionality of one or more of the preceding devices. As such, user computers 102-108 may include computers with a wide range of capabilities and features.

User computers 102-108 may access and/or employ various computing applications to enable users to perform various online and/or offline activities. Such activities may include, but are not limited to, generating documents, gathering/monitoring data, capturing/manipulating images, reviewing content, including but not limited to, user profile data, platform data, social referral data, and the like, managing media, managing financial information, playing games, managing personal information, browsing the Internet, or the like. In some embodiments, user computers 102-108 may be enabled to connect to a network through a browser, or other web-based application.

User computers 102-108 may further be configured to provide information that identifies the user computer. Such identifying information may include, but is not limited to, a type, capability, configuration, name, or the like, of the user computer. In at least one embodiment, a user computer may uniquely identify itself through any of a variety of mechanisms, such as an Internet Protocol (IP) address, phone number, Mobile Identification Number (MIN), media access control (MAC) address, electronic serial number (ESN), or other device identifier.

Various embodiments of IPAR 110 are described in more detail below in conjunction with network computer 300 of FIG. 3. At least one embodiment of IPAR 110 is described in conjunction with mobile computer 200 of FIG. 2. Briefly, in some embodiments, IPAR 110 may be operative provide content and/or data to one or more user computers 102-108. The data may include, but is not otherwise limited to resource management data, such as one or more reports. IPAR 110 may be operative to communicate with user computers 102-108 to provide users of user computers 102-108 the data. One or more engines may be implemented by, installed on, or otherwise instantiated on IPAR 110. For instance, IPAR 110 may include one or more engines, such as IPAR engine 222 of FIG. 2 or IPAR engine 322 of FIG. 3.

Various embodiments of MTSC 120 are described in more detail below in conjunction with network computer 300 of FIG. 3. At least one embodiment of MTSC 120 is described in conjunction with mobile computer 200 of FIG. 2. Briefly, in some embodiments, MTSC 120 may be operative to automatically generate, determine, analyze, and/or provide impact metrics and impact taxonomies to one or more user computers 102-108. MTSC 120 may be operative to communicate with user computers 102-108 to provide users of user computers 102-108 108 various resource management data. One or more engines may be implemented by, installed on, or otherwise instantiated on MTSC 120. For instance, MTSC 120 may include one or more engines, such as, but not limited to Impact Metrics engine 224 of FIG. 2 or Impact Metrics engine 324 of FIG. 3.

Various embodiments of RMSC 130 are described in more detail below in conjunction with network computer 300 of FIG. 3. At least one embodiment of RMSC 130 is described in conjunction with mobile computer 200 of FIG. 2. Briefly, in some embodiments, RMSC 130 may be operative to monitor one or more resources, such as but not limited to impact investment funds. For instance, RMSC 130 may include one or more engines, such as, but not limited to Resource Management engine 226 of FIG. 2 or Resource Management engine 326 of FIG. 3.

Network 108 may include virtually any wired and/or wireless technology for communicating with a remote device, such as, but not limited to, USB cable, Bluetooth™, Wi-Fi™, or the like. In some embodiments, network 108 may be a network configured to couple network computers with other computing devices, including user computers 102-108 and the like. In at least one of various embodiments, sensors may be coupled to network computers via network 108, which is not illustrated in FIG. 1. In various embodiments, information communicated between devices may include various kinds of information, including, but not limited to, processor-readable instructions, remote requests, server responses, program modules, applications, raw data, control data, system information (e.g., log files), video data, voice data, image data, text data, structured/unstructured data, or the like. In some embodiments, this information may be communicated between devices using one or more technologies and/or network protocols.

In some embodiments, such a network may include various wired networks, wireless networks, or any combination thereof. In various embodiments, the network may be enabled to employ various forms of communication technology, topology, computer-readable media, or the like, for communicating information from one electronic device to another. For example, the network can include—in addition to the Internet—LANs, WANs, Personal Area Networks (PANs), Campus Area Networks, Metropolitan Area Networks (MANs), direct communication connections (such as through a universal serial bus (USB) port), or the like, or any combination thereof.

In various embodiments, communication links within and/or between networks may include, but are not limited to, twisted wire pair, optical fibers, open air lasers, coaxial cable, plain old telephone service (POTS), wave guides, acoustics, full or fractional dedicated digital lines (such as T1, T2, T3, or T4), E-carriers, Integrated Services Digital Networks (ISDNs), Digital Subscriber Lines (DSLs), wireless links (including satellite links), or other links and/or carrier mechanisms known to those skilled in the art. Moreover, communication links may further employ any of a variety of digital signaling technologies, including without limit, for example, DS-0, DS-1, DS-2, DS-3, DS-4, OC-3, OC-12, OC-48, or the like. In some embodiments, a router (or other intermediate network device) may act as a link between various networks—including those based on different architectures and/or protocols—to enable information to be transferred from one network to another. In other embodiments, remote computers and/or other related electronic devices could be connected to a network via a modem and temporary telephone link. In essence, the network may include any communication technology by which information may travel between computing devices.

The network may, in some embodiments, include various wireless networks, which may be configured to couple various portable network devices, remote computers, wired networks, other wireless networks, or the like. Wireless networks may include any of a variety of sub-networks that may further overlay stand-alone ad-hoc networks, or the like, to provide an infrastructure-oriented connection for at least user computers 102-108 and the like. Such sub-networks may include mesh networks, Wireless LAN (WLAN) networks, cellular networks, or the like. In at least one of the various embodiments, the system may include more than one wireless network.

The network may employ a plurality of wired and/or wireless communication protocols and/or technologies. Examples of various generations (e.g., third (3G), fourth (4G), or fifth (5G)) of communication protocols and/or technologies that may be employed by the network may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra wide band (UWB), Wireless Application Protocol (WAP), user datagram protocol (UDP), transmission control protocol/Internet protocol (TCP/IP), any portion of the Open Systems Interconnection (OSI) model protocols, session initiated protocol/real-time transport protocol (SIP/RTP), short message service (SMS), multimedia messaging service (MMS), or any of a variety of other communication protocols and/or technologies. In essence, the network may include communication technologies by which information may travel between user computers 102-108, computers included in RM platform 140, other computing devices not illustrated, other networks, and the like.

In various embodiments, at least a portion of the network may be arranged as an autonomous system of nodes, links, paths, terminals, gateways, routers, switches, firewalls, load balancers, forwarders, repeaters, optical-electrical converters, or the like, which may be connected by various communication links. These autonomous systems may be configured to self organize based on current operating conditions and/or rule-based policies, such that the network topology of the network may be modified.

Illustrative Mobile computer

FIG. 2 shows one embodiment of mobile computer 200 that may include many more or less components than those shown. Mobile computer 200 may represent, for example, at least one embodiment of user computers 102-108, or a computer included in RM platform 140. So, mobile computer 200 may be a mobile device (e.g., a smart phone or tablet), a stationary/desktop computer, or the like.

Mobile computer 200 may include processor 202, such as a central processing unit (CPU), in communication with memory 204 via bus 228. Mobile computer 200 may also include power supply 230, network interface 232, processor-readable stationary storage device 234, processor-readable removable storage device 236, input/output interface 238, camera(s) 240, video interface 242, touch interface 244, projector 246, display 250, keypad 252, illuminator 254, audio interface 256, global positioning systems (GPS) receiver 258, open air gesture interface 260, temperature interface 262, haptic interface 264, pointing device interface 266, or the like. Mobile computer 200 may optionally communicate with a base station (not shown), or directly with another computer. And in one embodiment, although not shown, an accelerometer or gyroscope may be employed within mobile computer 200 to measuring and/or maintaining an orientation of mobile computer 200.

Additionally, in one or more embodiments, the mobile computer 200 may include logic circuitry 268. Logic circuitry 268 may be an embedded logic hardware device in contrast to or in complement to processor 202. The embedded logic hardware device would directly execute its embedded logic to perform actions, e.g., an Application Specific Integrated Circuit (ASIC), Field Programmable Gate Array (FPGA), and the like.

Also, in one or more embodiments (not shown in the figures), the mobile computer may include a hardware microcontroller instead of a CPU. In at least one embodiment, the microcontroller would directly execute its own embedded logic to perform actions and access it's own internal memory and it's own external Input and Output Interfaces (e.g., hardware pins and/or wireless transceivers) to perform actions, such as System On a Chip (SOC), and the like.

Power supply 230 may provide power to mobile computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling mobile computer 200 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of mobile computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the mobile device is powered. Also, illuminator 254 may backlight these buttons in various patterns when particular actions are performed, such as dialing another mobile computer. Illuminator 254 may also cause light sources positioned within a transparent or translucent case of the mobile device to illuminate in response to actions.

Mobile computer 200 may also comprise input/output interface 238 for communicating with external peripheral devices or other computers such as other mobile computers and network computers. Input/output interface 238 may enable mobile computer 200 to communicate with one or more servers, such as IPAR 110 of FIG. 1. In some embodiments, input/output interface 238 may enable mobile computer 200 to connect and communicate with one or more network computers, user computers 102-108 of FIG. 1. Other peripheral devices that mobile computer 200 may communicate with may include remote speakers and/or microphones, headphones, display screen glasses, or the like. Input/output interface 238 can utilize one or more technologies, such as Universal Serial Bus (USB), Infrared, Wi-Fi, WiMax, Bluetooth™, wired technologies, or the like.

Haptic interface 264 may be arranged to provide tactile feedback to a user of a mobile computer 200. For example, the haptic interface 264 may be employed to vibrate mobile computer 200 in a particular way when another user of a computer is calling. Temperature interface 262 may be used to provide a temperature measurement input and/or a temperature changing output to a user of mobile computer 200. Open air gesture interface 260 may sense physical gestures of a user of mobile computer 200, for example, by using single or stereo video cameras, radar, a gyroscopic sensor inside a computer held or worn by the user, or the like. Camera 240 may be used to track physical eye movements of a user of mobile computer 200.

GPS transceiver 258 can determine the physical coordinates of mobile computer 200 on the surface of the Earth, which typically outputs a location as latitude and longitude values. Physical coordinates of a mobile computer that includes a GPS transceiver may be referred to as geo-location data. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of mobile computer 200 on the surface of the Earth. It is understood that under different conditions, GPS transceiver 258 can determine a physical location for mobile computer 200. In at least one embodiment, however, mobile computer 200 may, through other components, provide other information that may be employed to determine a physical location of the mobile computer, including for example, a Media Access Control (MAC) address, IP address, and the like.

In at least one embodiment, GPS transceiver 258 is employed for localization of the various embodiments discussed herein. For instance, the various embodiments may be localized, via GPS transceiver 258, to customize the linguistics, technical parameters, time zones, configuration parameters, units of measurement, monetary units, and the like based on the location of a user of mobile computer 200. In a least one embodiment, a localization of at least a portion of any application included in mobile computer 200, such as but not limited to resource management client 222, is performed based on at least the geo-location data or other data acquired by GPS transceiver 258 or other sensors included in mobile computer 200. For instance, time zone parameters, currency type, units, language parameters, and the like are set or otherwise configured in various portions of software included in one or more mobile computers. Furthermore, any process discussed herein, including but not limited to any process discussed in the context of any flowchart described herein, may be localized as such.

Human interface components can be peripheral devices that are physically separate from mobile computer 200, allowing for remote input and/or output to mobile computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile computer with such peripheral human interface components is a wearable computer, which might include a remote pico projector along with one or more cameras that remotely communicate with a separately located mobile computer to sense a user's gestures toward portions of an image projected by the pico projector onto a reflected surface such as a wall or the user's hand.

A mobile computer 200 may include a browser application that is configured to receive and to send web pages, web-based messages, graphics, text, multimedia, and the like. Mobile computer's 200 browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

In various embodiments, the browser application may be configured to enable a user to log into an account and/or user interface to access/view data, such as but not limited to resource management data. In at least one of various embodiments, the browser may enable a user to view reports of resource management data that is generated by RM platform 140 of FIG. 1. In some embodiments, the browser/user interface may enable the user to customize a view of the report. As described herein, the extent to which a user can customize the reports may depend on permissions/restrictions for that particular user. A user of mobile computer 200 may be provided features of the various platforms discussed herein, including any of the user interfaces discussed herein, via the browser application of mobile computer 200.

Memory 204 may include RAM, ROM, and/or other types of memory. Memory 204 illustrates an example of computer-readable storage media (devices) for storage of information such as computer-readable instructions, data structures, program modules or other data. Memory 204 may store system firmware 208 (e.g., BIOS) for controlling low-level operation of mobile computer 200. The memory may also store operating system 206 for controlling the operation of mobile computer 200. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 204 may further include one or more data storage 210, which can be utilized by mobile computer 200 to store, among other things, applications 220 and/or other data. For example, data storage 210 may store resource management data 212. Resource management data 212 may include any of the data discussed herein, as structured or unstructured data. Data storage 210 may further include program code, data, algorithms, and the like, for use by a processor, such as processor 202 to execute and perform actions. In one embodiment, at least some of data storage 210 might also be stored on another component of mobile computer 200, including, but not limited to, non-transitory processor-readable removable storage device 236, processor-readable stationary storage device 234, or even external to the mobile device. Removable storage device 236 may be a USB drive, USB thumb drive, dongle, or the like. At least one of memory 204, removable storage device 236, or processor-readable stationary storage 234 may include non-transitory storage media.

Applications 220 may include computer executable instructions which, when executed by mobile computer 200, transmit, receive, and/or otherwise process instructions and data. Applications 220 may include one or more engines, such as but not limited to at least one of an IPAR engine 222, and impact metrics engine 224, or a resource management engine 226. Other engines may be included in applications 220. In at least one embodiment, at least portions of IPAR engine 222, impact metrics engine 224, and resource management engine 226 may be combined into a single engine, such as but not limited to a resource management engine that is enabled to perform at least portions of the functionality of each of the of IPAR engine 222, impact metrics engine 224, and resource management engine 226.

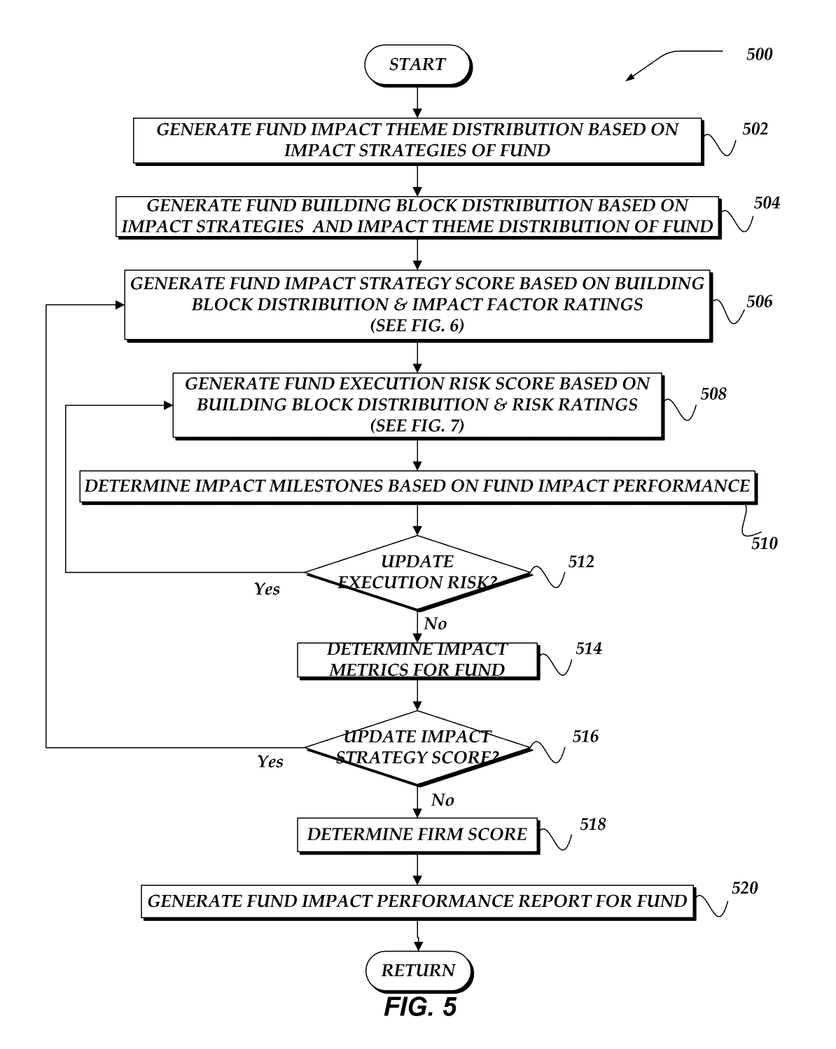

Either singly, or in various combinations, the IPAR engine 222, impact metrics engine 224, and resource management engine 226 may perform the processes, or at least portions of the processes described herein. For instance, in some embodiments, either singly, or in combination, these engines may perform at least portions of processes 500, 600, and 700 described in conjunction with FIGS. 5-7. Such engines may be implemented in, or at least are communicatively coupled to and enabled to receive and provide data from and to RM platform 140 or any user computer. At least one these engines may include one or more servers, such as but not limited to server(s) 328 of network computer 300 of FIG. 3. Applications 220 may include one or more clients 228 that interact with one or more servers and/or engines. A user of mobile computer 200 may be provided certain functionalities of the platform via a browser application, such as a web browser.

Other examples of application programs that may be included in applications 220 include, but are not limited to, calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

So, in some embodiments, mobile computer 200 may be enabled to employ various embodiments, combinations of embodiments, processes, or parts of processes, as described herein. Moreover, in various embodiments, mobile computer 200 may be enabled to employ various embodiments described above in conjunction with computer device of FIG. 1.

### Illustrative Network Computer

FIG. 3 shows one embodiment of network computer 300, according to one embodiment of the invention. Network computer 300 may represent, for example, at least one embodiment of user computers 102-108 or a computer included in RM platform 140. Network computer 300 may be a desktop computer, a laptop computer, a server computer, a client computer, and the like.

Network computer 300 may include processor 302, such as a CPU, processor readable storage media 328, network interface unit 330, an input/output interface 332, hard disk drive 334, video display adapter 336, GPS 338, and memory 304, all in communication with each other via bus 338. In some embodiments, processor 302 may include one or more central processing units.

Additionally, in one or more embodiments (not shown in the figures), the network computer may include an embedded logic hardware device instead of a CPU. The embedded logic hardware device would directly execute its embedded logic to perform actions, e.g., an Application Specific Integrated Circuit (ASIC), Field Programmable Gate Array (FPGA), and the like.

Also, in one or more embodiments (not shown in the figures), the network computer may include a hardware microcontroller instead of a CPU. In at least one embodiment, the microcontroller would directly execute its own embedded logic to perform actions and access its own internal memory and its own external Input and Output Interfaces (e.g., hardware pins and/or wireless transceivers) to perform actions, such as System On a Chip (SOC), and the like.

As illustrated in FIG. 3, network computer 300 also can communicate with the Internet, cellular networks, or some other communications network (either wired or wireless), via network interface unit 330, which is constructed for use with various communication protocols. Network interface unit 330 is sometimes known as a transceiver, transceiving device, or network interface card (NIC). In some embodiments, network computer 300 may communicate with a user computer, or a computer included in an RM platform 140, or any other network computer, via the network interface unit 320.

Network computer 300 also comprises input/output interface 332 for communicating with external devices, such as a various sensors or other input or output devices not shown in FIG. 3. Input/output interface 332 can utilize one or more communication technologies, such as USB, infrared, Bluetooth™, or the like.

Memory 304 generally includes RAM, ROM and one or more permanent mass storage devices, such as hard disk drive 334, tape drive, optical drive, and/or floppy disk drive. Memory 304 may store system firmware 306 for controlling the low-level operation of network computer 300 (e.g., BIOS). In some embodiments, memory 304 may also store an operating system for controlling the operation of network computer 300.

Although illustrated separately, memory 304 may include processor readable storage media 328. Processor readable storage media 342 may be referred to and/or include computer readable media, computer readable storage media, and/or processor readable storage device. Processor readable removable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 304 further includes one or more data storage 310, which can be utilized by network computer 300 to store, among other things, resource management data 312 and/or other data. Resource management data 312 may include any of the data discussed herein, as structured or unstructured data Data storage 310 may further include program code, data, algorithms, and the like, for use by a processor, such as processor 302 to execute and perform actions. In one embodiment, at least some of data storage 310 might also be stored on another component of network computer 300, including, but not limited to processor-readable storage media 328, hard disk drive 334, or the like.

Applications 320 may include computer executable instructions that can execute on processor 302 to perform actions. In some embodiments, one or more of applications 320 may be part of an application that may be loaded into mass memory and run on an operating system

Applications 320 may include one or more engines, such as but not limited to at least one of an IPAR engine 322, and impact metrics engine 324, or a resource management engine 326. Other engines may be included in applications 320. In at least one embodiment, at least portions of IPAR engine 322, impact metrics engine 324, and resource management engine 326 may be combined into a single engine, such as but not limited to a resource management engine that is enabled to perform at least portions of the functionality of each of the of IPAR engine 322, impact metrics engine 324, and resource management engine 326.

Either singly, or in various combinations, the IPAR engine 322, impact metrics engine 324, and resource management engine 326 may perform the processes, or at least portions of the processes described herein. For instance, in some embodiments, either singly, or in combination, these engines may perform at least portions of processes 500, 600, and 700 described in conjunction with FIGS. 5-7. Such engines may be implemented in, or at least are communicatively coupled to and enabled to receive and provide data from and to RM platform 140 or any user computer. At least one these engines may include one or more servers, such as but not limited to server(s) 328. Applications 320 may include one or more clients, such as but not limited to client 228 of mobile computer 200 of FIG. 200. A user of network computer 300 may be provided certain functionalities of the platform via a browser application, such as a web browser.

GPS transceiver 358 can determine the physical coordinates of network computer 300 on the surface of the Earth, which typically outputs a location as latitude and longitude values. Physical coordinates of a network computer that includes a GPS transceiver may be referred to as geo-location data. GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 358 can determine a physical location for network computer 300. In at least one embodiment, however, network computer 300 may, through other components, provide other information that may be employed to determine a physical location of the mobile computer, including for example, a Media Access Control (MAC) address, IP address, and the like.

In at least one embodiment, GPS transceiver 358 is employed for localization of the various embodiments discussed herein. For instance, the various embodiments may be localized, via GPS transceiver 358, to customize the linguistics, technical parameters, time zones, configuration parameters, units of measurement, monetary units, and the like based on the location of a user of network computer 300. In a least one embodiment, a localization of at least a portion of any application included in network computer 300, such as but not limited to resource management server 322, is performed based on at least the geo-location data or other data acquired by GPS transceiver 358 or other sensors included in network computer 300. For instance, time zone parameters, currency type, units, language parameters, and the like are set or otherwise configured in various portions of software included in one or more network computers. Furthermore, any process discussed herein, including but not limited to any process discussed in the context of any flowchart described herein, may be localized as such.

Audio interface 364 may be arranged to produce and receive audio signals such as the sound of a human voice. For example, audio interface 354 may be coupled to a speaker and microphone (not shown) to enable telecommunication with others and/or generate an audio acknowledgement for some action. A microphone in audio interface 364 can also be used for input to or control of network computer 300, e.g., using voice recognition, detecting touch based on sound, and the like. Likewise, a camera 340 may be included with network computer 300 to capture image and/or video data. Other sensors 360 may be included to sense a location, or other environment component.

Additionally, in one or more embodiments, the network computer 300 may include logic circuitry 362. Logic circuitry 362 may be an embedded logic hardware device in contrast to or in complement to processor 302. The embedded logic hardware device would directly execute its embedded logic to perform actions, e.g., an Application Specific Integrated Circuit (ASIC), Field Programmable Gate Array (FPGA), and the like.

So, in some embodiments, network computer 300 may be enabled to employ various embodiments, combinations of embodiments, processes, or parts of processes, as described herein. Moreover, in various embodiments, network computer 300 may be enabled to employ various embodiments described above in conjunction with computer device of FIG. 1.

### Illustrative Logical System Architecture

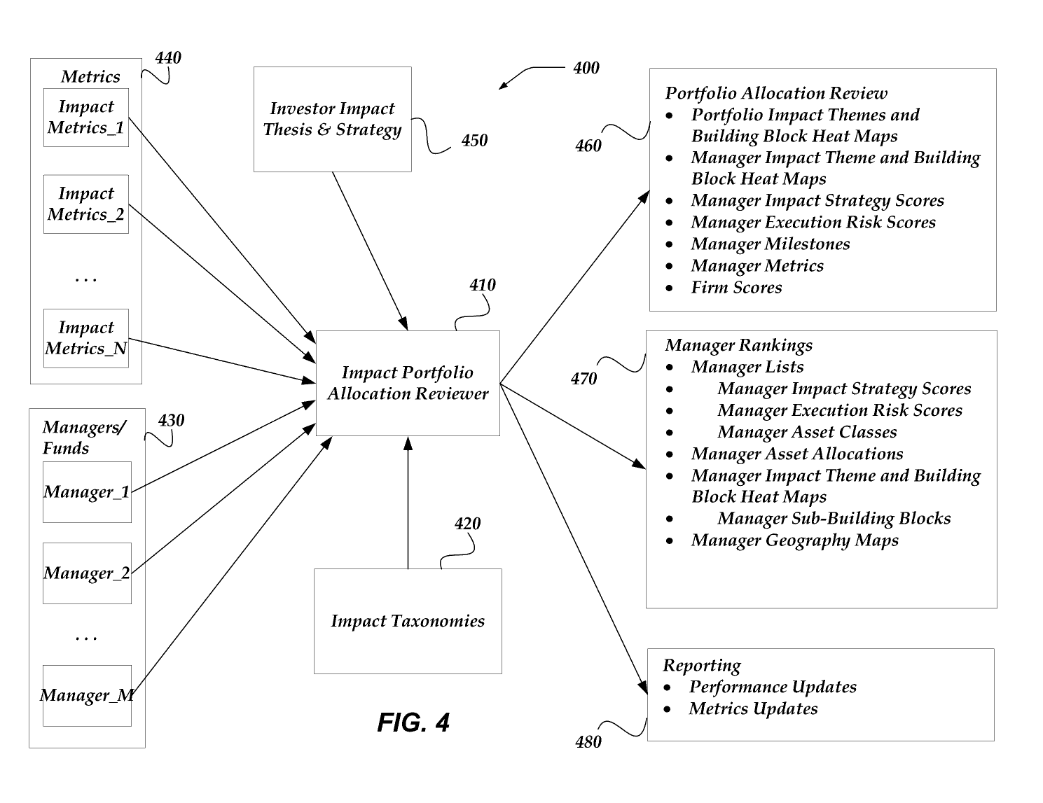

FIG. 4 shows a logical schematic of system 400 in accordance with at least one of the various embodiments. System 400 includes an Impact Portfolio Allocation Reviewer (IPAR) 410. At least portions of IPAR 410 may be at least partially be implemented on at least one of a server device, such as any of portfolio allocation review server 112, impact metrics/taxonomy server 114, or fund manager server 116 of FIG. 1. Furthermore, portions of IPAR 410 may be implemented on a client device, such as client device 200 of FIG. 2, and/or a network device, such as network device 300 of FIG. 3. IPAR 410 is operative to organize impact investing due diligence conclusions. For instance, IPAR 410 may be employed for a bottom-up review of any impact investment or grant. IPAR 410 is further operative to classify and evaluate a diverse plurality of impact investment strategies and provide a top-down perspective on impact portfolio construction. IPAR 410 is operative to generate both pre- and post-investment impact and risk evaluations for a plurality of asset classes, including at least real assets, private investments, alternative investments, public equity, and fixed income investments.

IPAR 410 analyzes and/or evaluates investments or grants based on a plurality of components of the overall impact strategy of an investor and/or fund manager and a plurality of components of the overall execution risk. IPAR 410 provides ongoing and real-time monitoring and reporting of strategic objectives and related risk reduction at the portfolio, fund, or manager level. IPAR 410 enables users to apply a standardized framework to investments in every asset class, as well as to philanthropic grants and analyzes various investing due diligence components, as well as provides a standardized and robust reporting of the impact performance of the various funds that are included in an investor's portfolio.

To evaluate standardized measurements of impact investments, system 400 provides IPAR 410 with data and information from various sources. In some embodiments, various impact taxonomies 420 are provided to IPAR 410. In various embodiments, a taxonomy server, such as impact metrics/taxonomy server 114 of FIG. 1, provides or receives one or more impact taxonomies 420. One such non-limiting example of an impact taxonomy 420 that is provided to IPAR 410 is the Impact Reporting and Investment Standards (IRIS) taxonomy. The IRIS taxonomy includes a catalog of performance metrics that impact investors may use to measure social, environmental, and financial success of investment instruments. Each IRIS metric includes a standardized definition to provide a foundation for an impact measurement system and/or relative comparison.

In various embodiments, IPAR 410 determines absolute evaluations and relative comparisons among a plurality of impact funds, fund managers, firms, and the like. Accordingly, a plurality of mangers and/or funds 430 provides various information and/or data to IPAR 410. In some embodiments, data included in managers and/or funds 430 may be structured data and/or include data structures. For instance, the impact managers be included in one or more data structures. Such data structure may be nested data structures or include sub-data structures.

In various embodiments, a fund manager server, such as fund manager server 116 of FIG. 1, provides and/or receives various fund information from the plurality of managers and/or funds 430. One non-limiting example of such information that each of a plurality of managers and/or funds 430 provides IPAR 410 is the sub-building blocks, or simply sub-blocks, that are associated with each of the impact building blocks and impact themes of the fund that the manager is managing.

Some of the plurality of managers/funds 430 may provide various impact or financial performance metrics or measurements of the funds. Furthermore, the managers/funds 430 may provide at least one of an impact theme distribution or a building block distribution of the fund. Some of the managers/funds 430 may provide milestones or roadmaps for the funds. For instance, an manager may periodically provide an updated roadmap that includes information regarding whether various impact milestones associated with the fund were achieved, are incomplete, in progress, or substantial work towards the milestone will begin in the future. At least one manger/fund 430 may provide an impact thesis and/or impact strategy for the fund. Additionally, an impact investor may provide an impact thesis and/or strategy 450. Such an investor impact thesis may include at least one of a desired or optimal impact theme distribution or a building block distribution.

A plurality of impact performance metrics 440 are provided to IPAR 410. In some embodiments, data included in performance metrics 440 may be structured data and/or include data structures. For instance, the impact metrics may be included in one or more data structures. Such data structure may be nested data structures or include sub-data structures.

In various embodiments, financial performance metrics are also provided to IPAR 410. For instance, impact metrics/taxonomy server 114 may provide one or more metrics to IPAR 410. The plurality of impact performance metrics 440 may include an industry standard impact performance metric, such as but not limited to IRIS metrics, B Impact Assessment metrics, Global Impact Investing Rating System (GIIRS) metrics, Human Impact and Profit (HIPS) metrics, Social Return on Investment metrics (SROI), PULSE metrics, and the like. In various embodiments, values for one or more of the plurality of impact metrics 440 are provided for one or more of the funds/managers being tracked by IPAR 410. As discussed further below, IPAR 410 employs one or more of industry standard impact metrics provided a standardized measurement of an impact strategy and an execution risk of one or more funds that are tracked by IPAR 410. Furthermore, IPAR 410 employs the plurality of metrics 410 to organize funds, managers, and/or portfolios into a distribution of impact themes, building blocks, and sub-building blocks.

Upon analyzing and/or evaluating the provided information, IPAR 410 generates a portfolio allocation review 460 for an investor impact thesis 450. In some embodiments, data and/or information included in allocation review 460 and/or investor impact thesis 450 may be structured data and/or include data structures. For instance, the impact themes distributions, building block distributions, and the like may be included in one or more data structures. Such data structure may be nested data structures or include sub-data structures. For instance, the portfolio data structure may include building block distributions that are sub-data structures to impact theme distribution data structures.

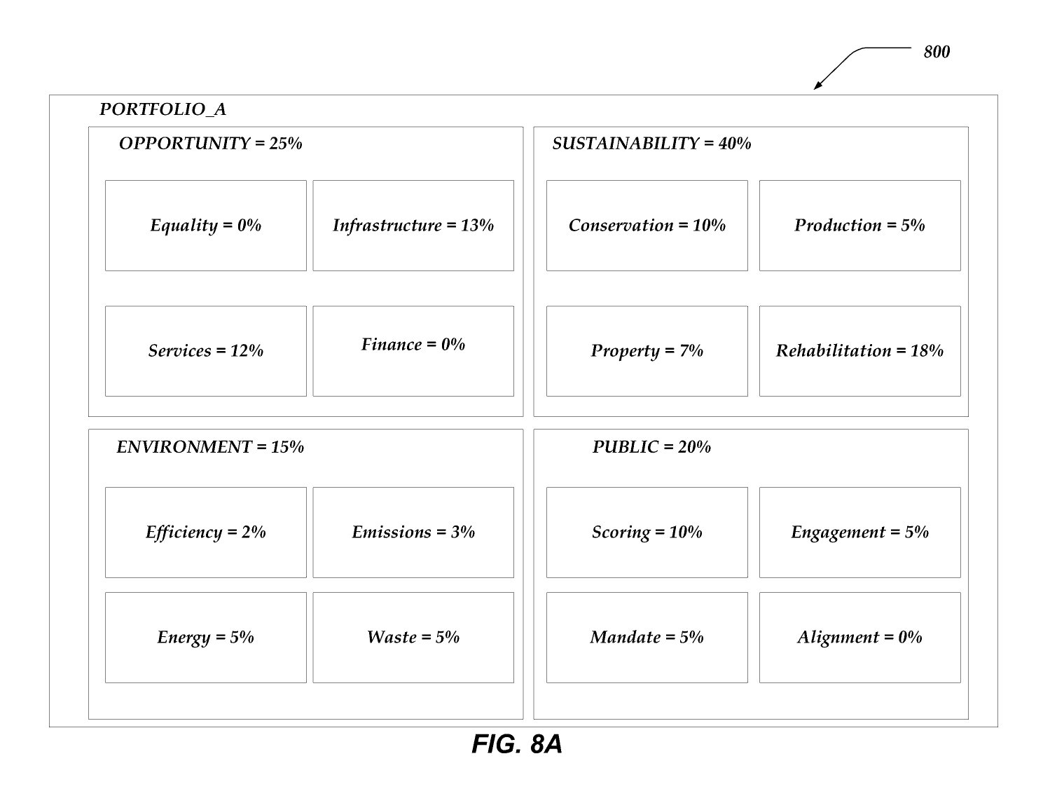

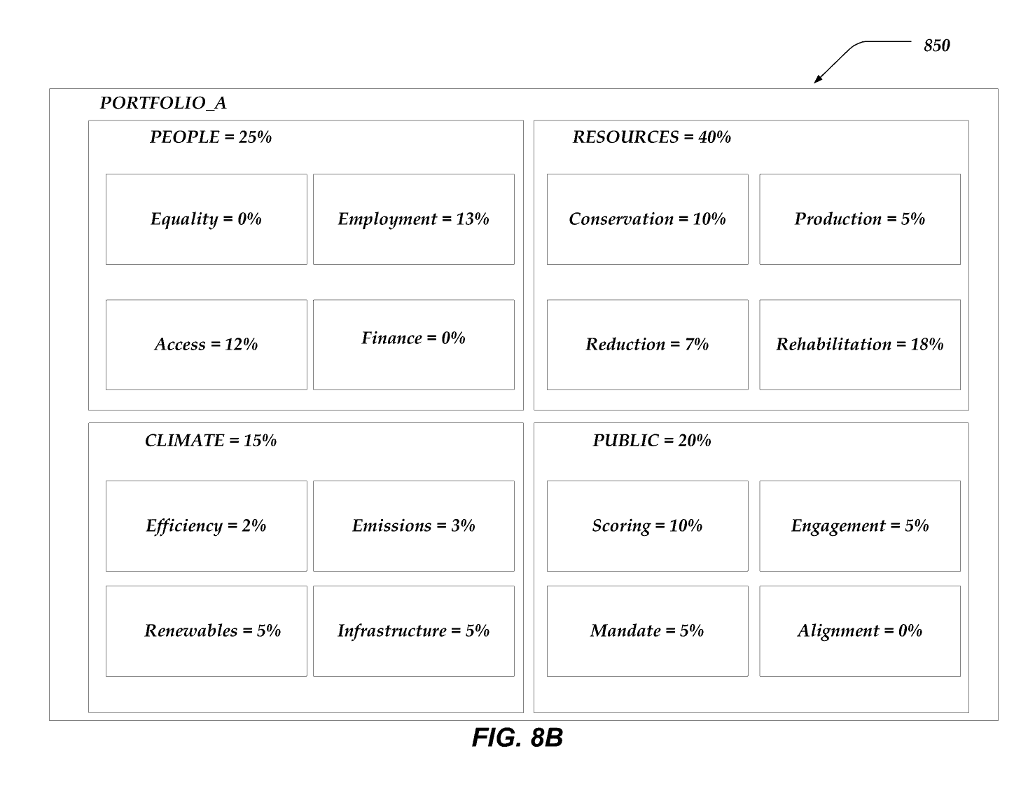

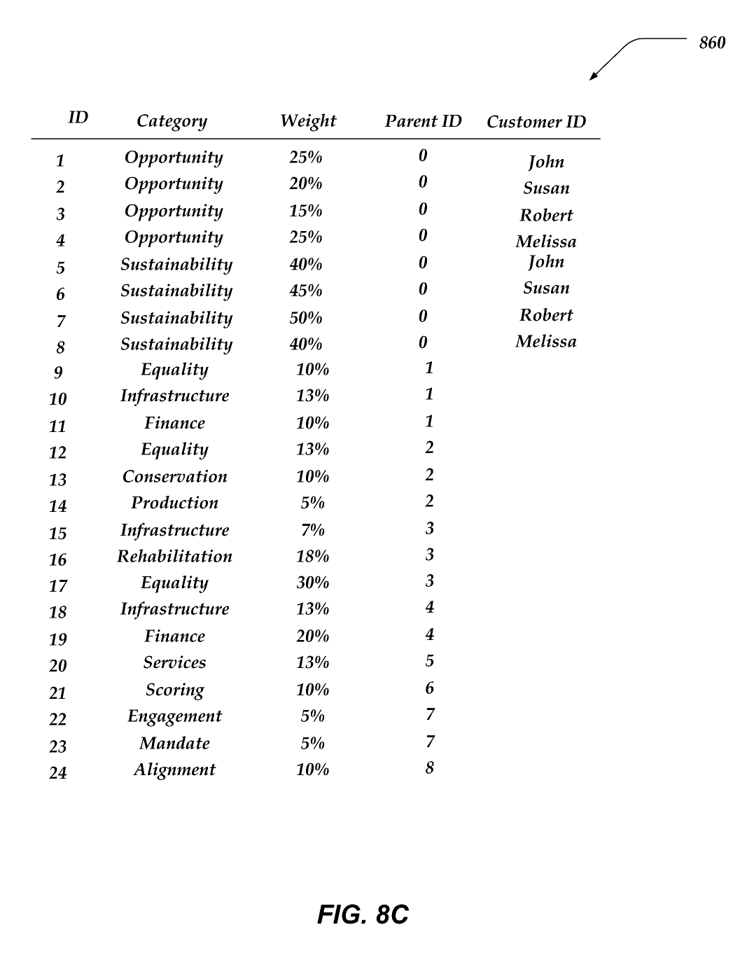

The allocation review 460 may include an impact theme and a building block heat map for the portfolio under review. Such heat maps provide a visual display of the relative impact theme/build block concentrations of the impact across investor portfolio and asset classes. In various embodiments, visual displays or user interfaces that include heat maps may are color-coded and/or employ graphics or icons of relative sized to visually demonstrate the relative sizes of the various components in the impact theme or building block distributions. FIG. 8A shows one such visual display 800 of a portfolio impact theme and building block heat map for PORTFOLIO_A. FIG. 8B shows another visual display 850 embodiment of a portfolio impact theme and building block heat map for PORTFOLIO_A.

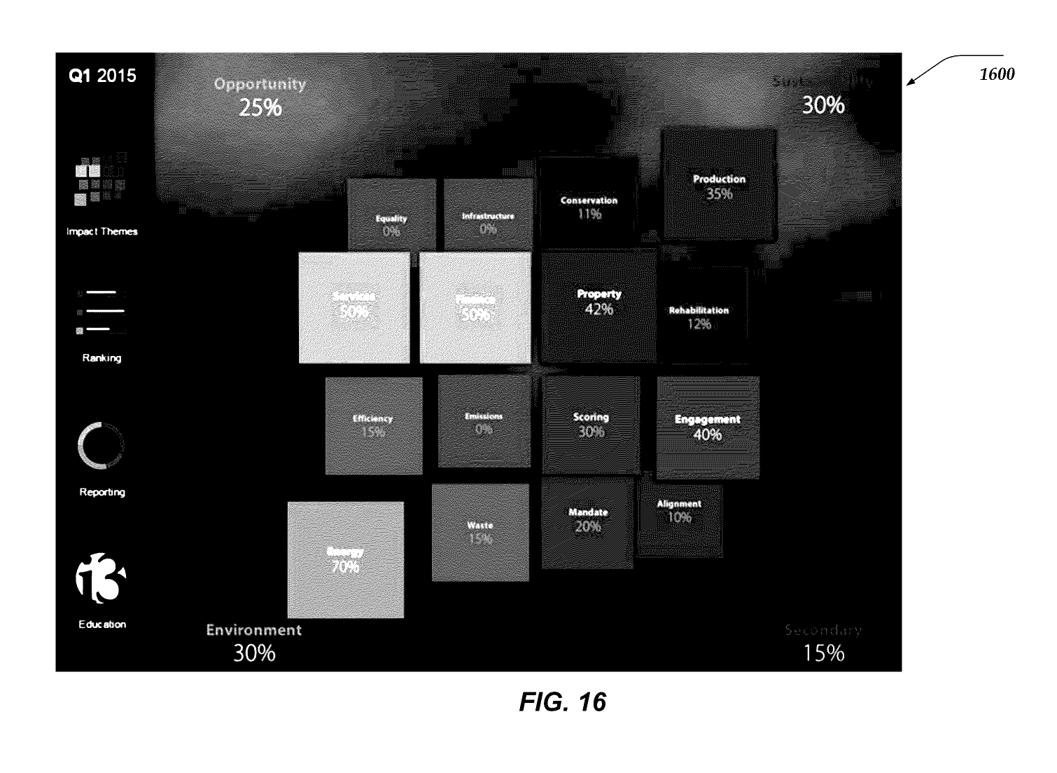

An alternative visual display 1600 is shown in FIG. 16. The icons representing each of the building blocks in visual display 1600 are relatively sized to represent the size of each component in the distribution. The icons that represent building block components with significantly non-zero values are shown “popping out” of the screen. The icons are also color codes. Thus, the arrangement, sizes, and colors shown in visual display 1600 provide a unique visual identifier for a particular fund manager.

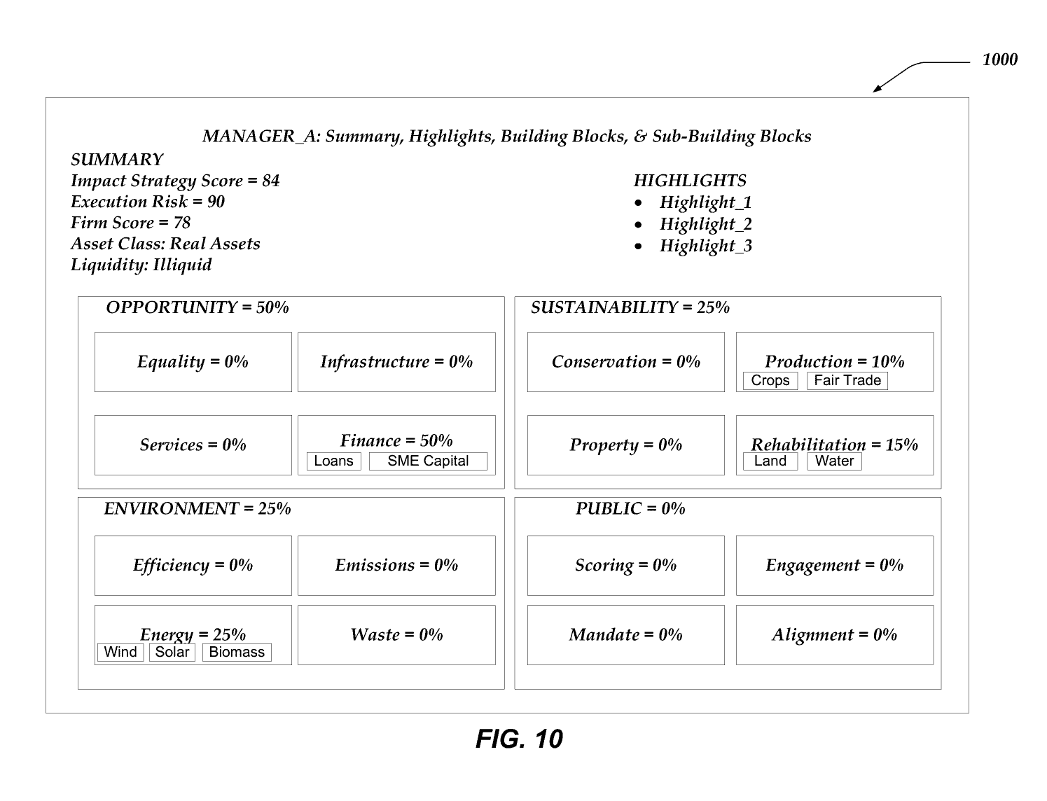

In various embodiments, portfolio allocation review 460 may also provide impact theme and building block heat maps and other information for each of the funds or managers of funds that are included in the portfolio under review. FIG. 10 shows an interface 1000 that provides the impact theme and building block heat maps for Manager_A, of which PORTFOLIO_A holds positions in a fund managed by Manager_A. Interface 1000 also provides summary and highlight information for Manager_A, such as the impact strategy score, execution risk, and the firm score associated with Manager_A.

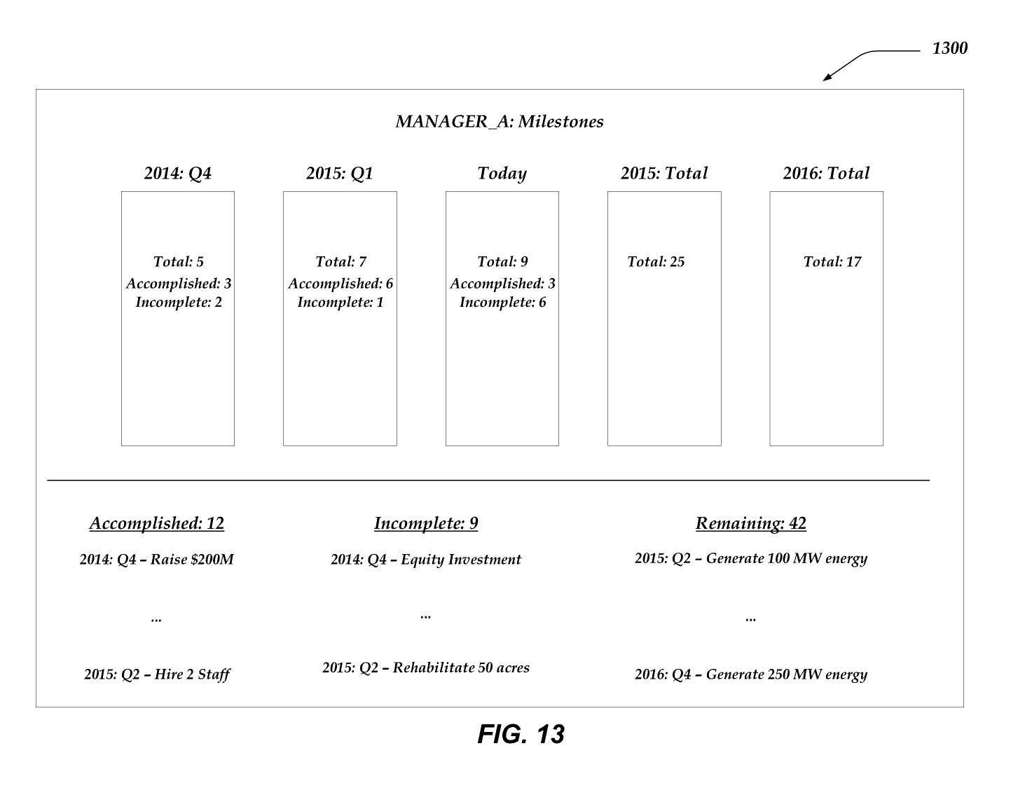

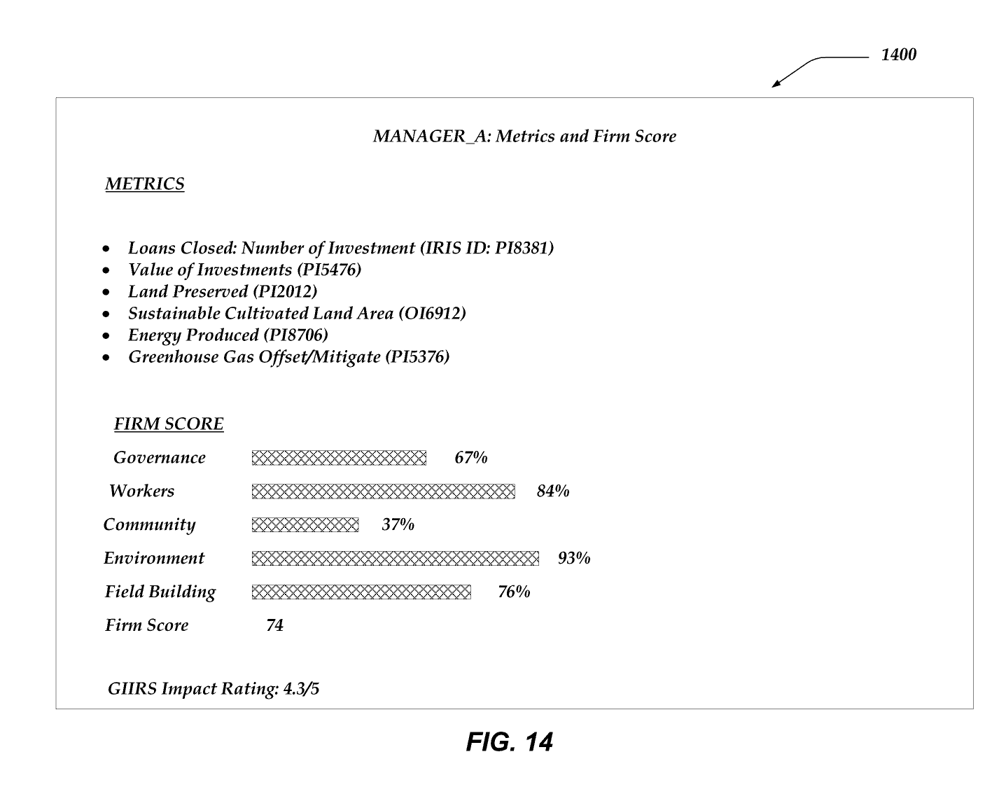

Portfolio allocation review 460 may further provide milestones and metrics, as well as other impact metrics for each of the funds or managers of funds that are included in a portfolio under review. FIG. 13 shows an interface 1300 that provides the roadmap, milestones, and status of various milestone for Manager_A. Likewise, FIG. 14 shows an interface 1400 that provides impact metrics, firm scores, and an impact rating for Manager_A.

The firm score is separate and independent from both the impact strategy score and execution risk score. In various embodiments, the firm score is based on a firm questionnaire, which imparts insight into critical areas of the fund's sustainable, impact-driven business management. In at least one embodiment, a GIIRS rating may be paired with the firm rating. Accordingly, the user is presented with several evaluations that provide a quantification of the fund manager's commitment to the impact thesis.

In at least some embodiments, an activation percentage is determined for some funds under review or analysis. The activation percentage refers to the impact intentionality of the fund or manager, namely focusing the fund's likelihood of generating social and/or environmental impacts, as well as a financial return. The activation percentage reflects a dollar-weighted basis of the pace of impact conversion undertaken within the portfolio. The action percentage may be tracked and/or updated over time.

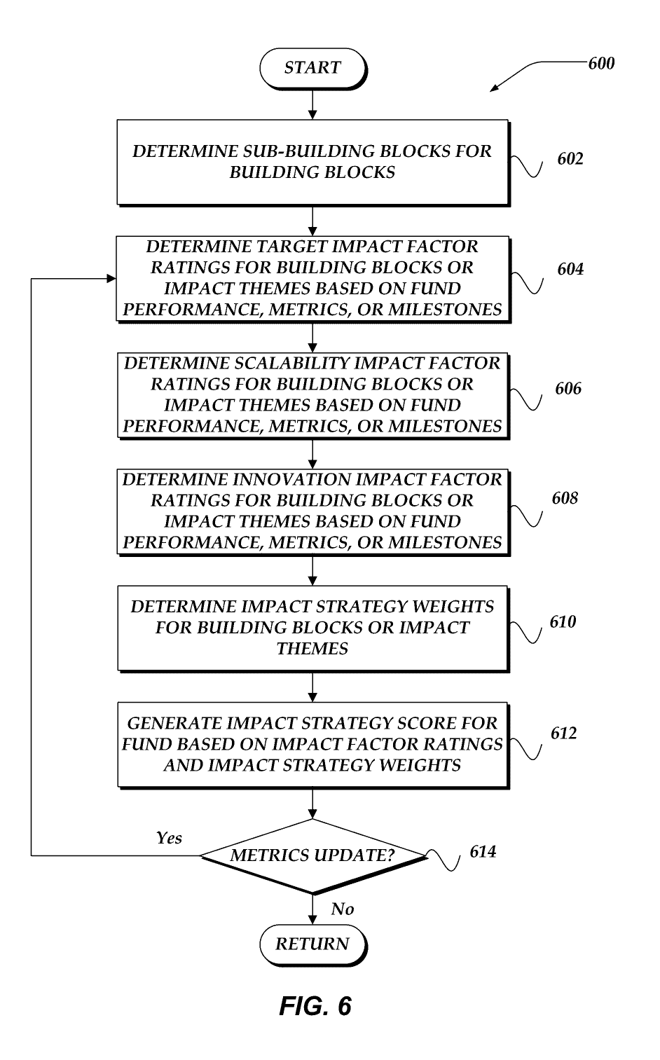

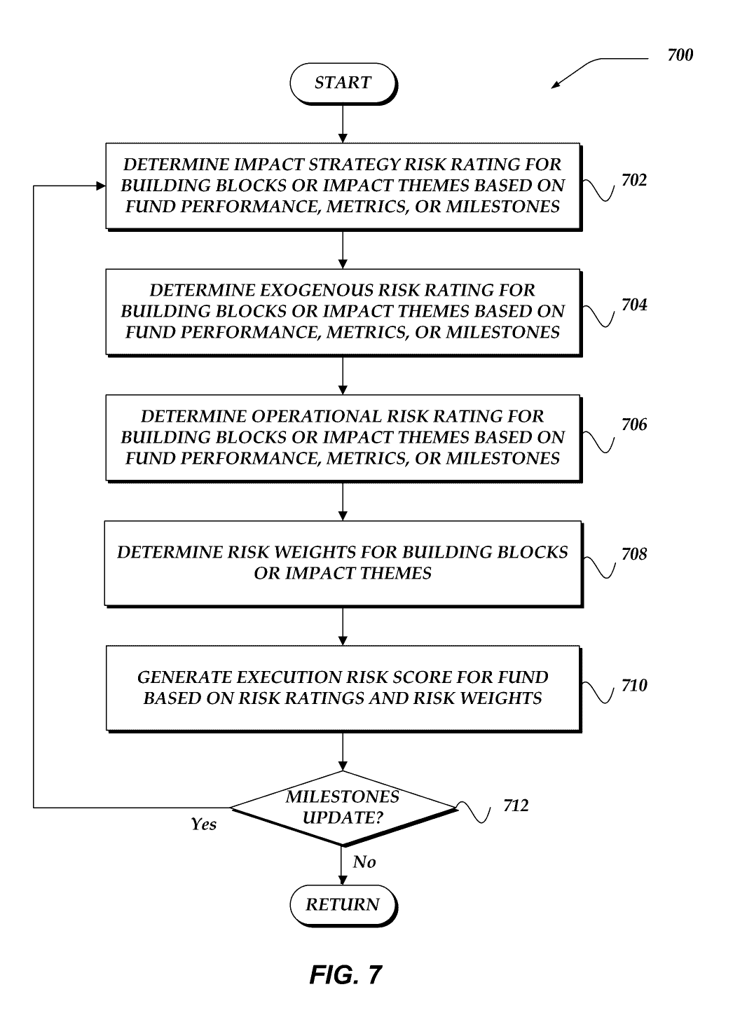

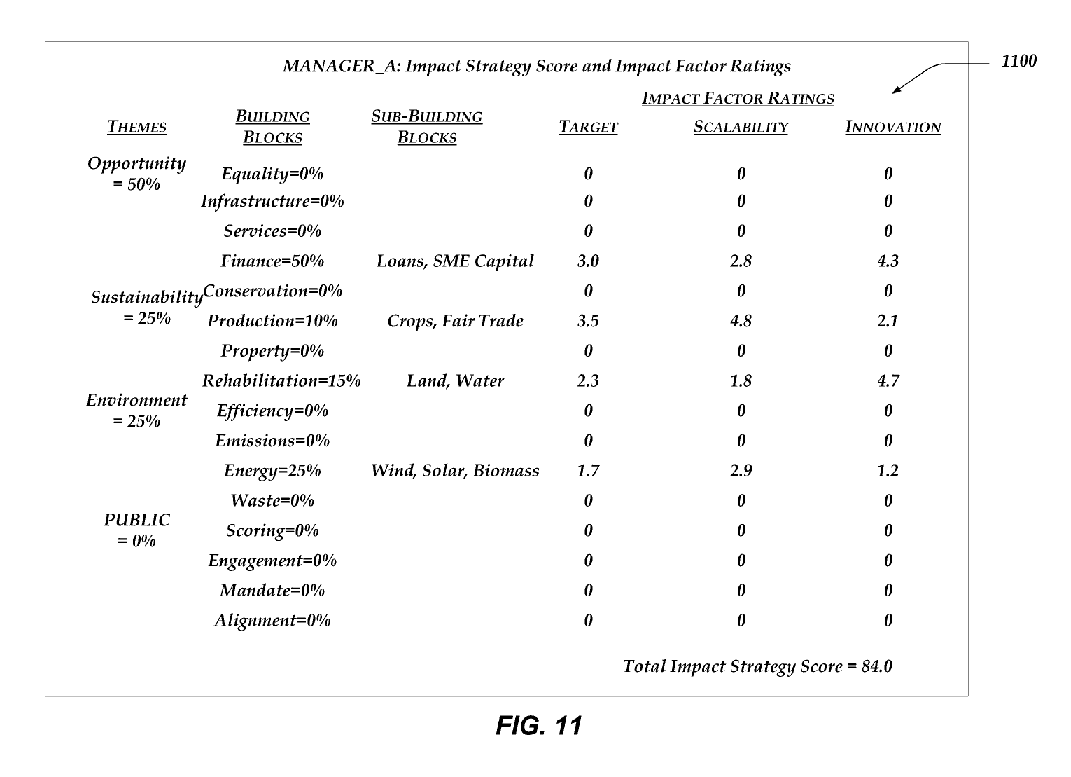

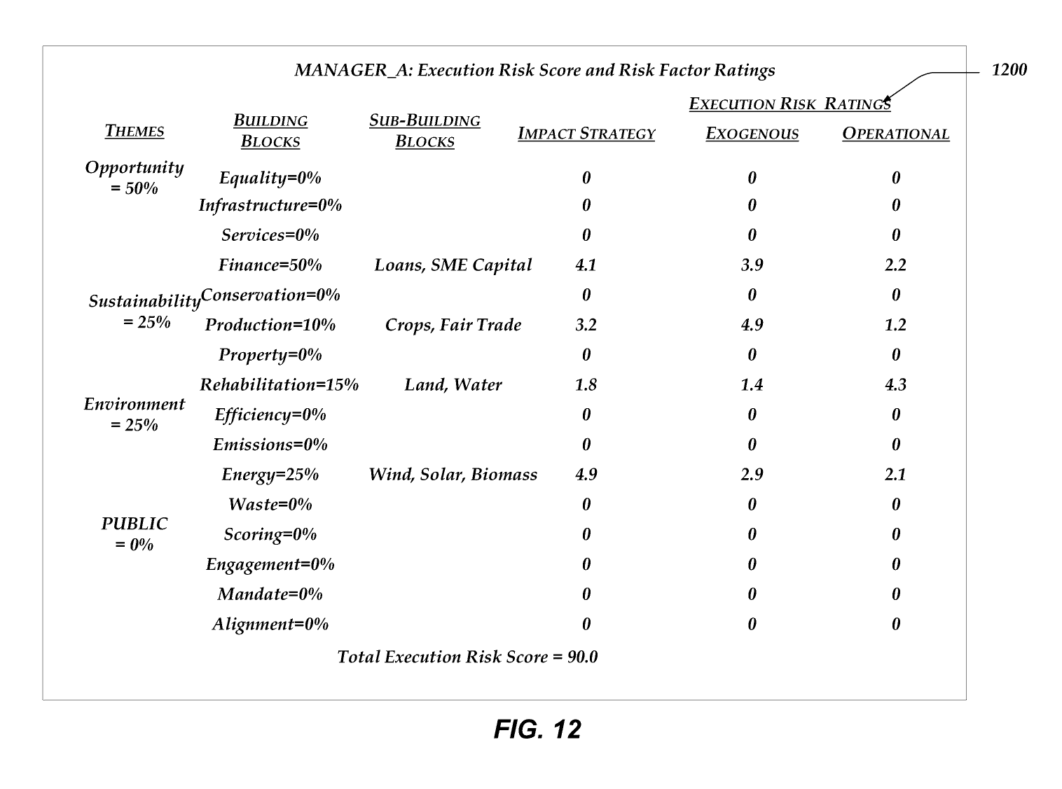

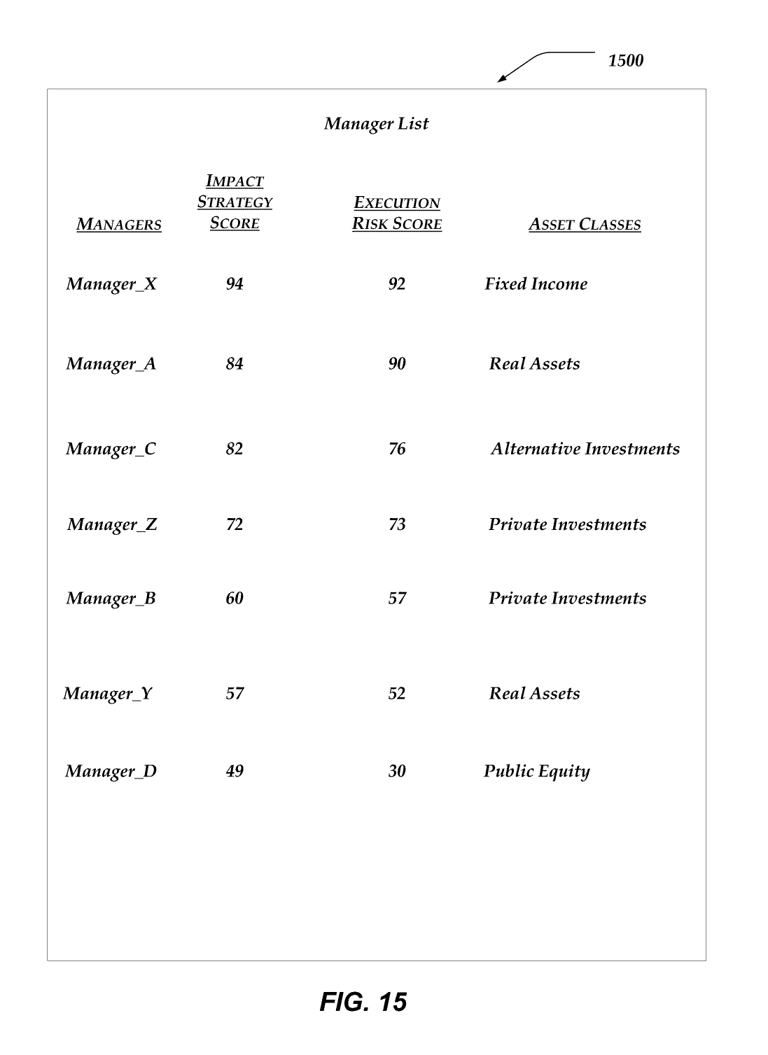

IPAR 410 also generates manager rankings 470 based on the analysis and/or evaluation of one or more funds or managers of funds. A manager ranking 470 may include a manager list. One non-limiting exemplary embodiment of a manager list is shown in interface 1500 of FIG. 15. Interface 1500 shows a listing of manager rankings based on at least one of an impact strategy score, execution risk score, or one or more asset classes associated with the listed managers of funds. The generation and/or determination of impact strategy score is discussed further in regards to at least FIGS. 6 and 11. Likewise, the generation and/or determination of execution risk scores is discussed further in regards to at least FIGS. 7 and 12.

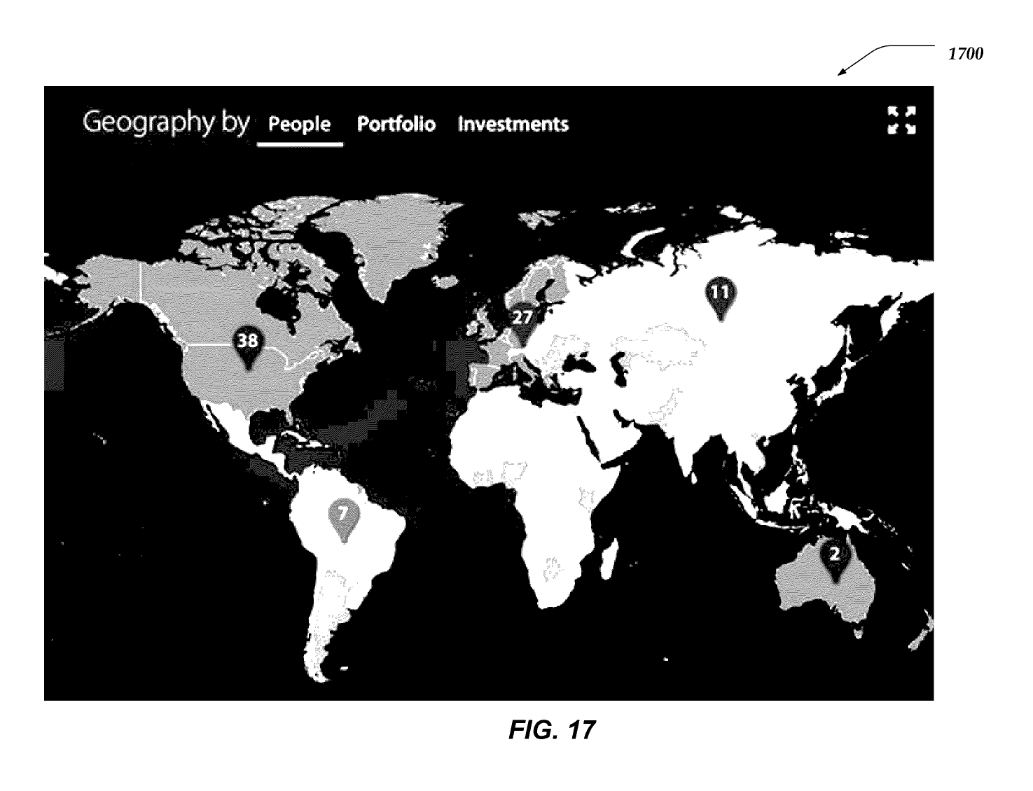

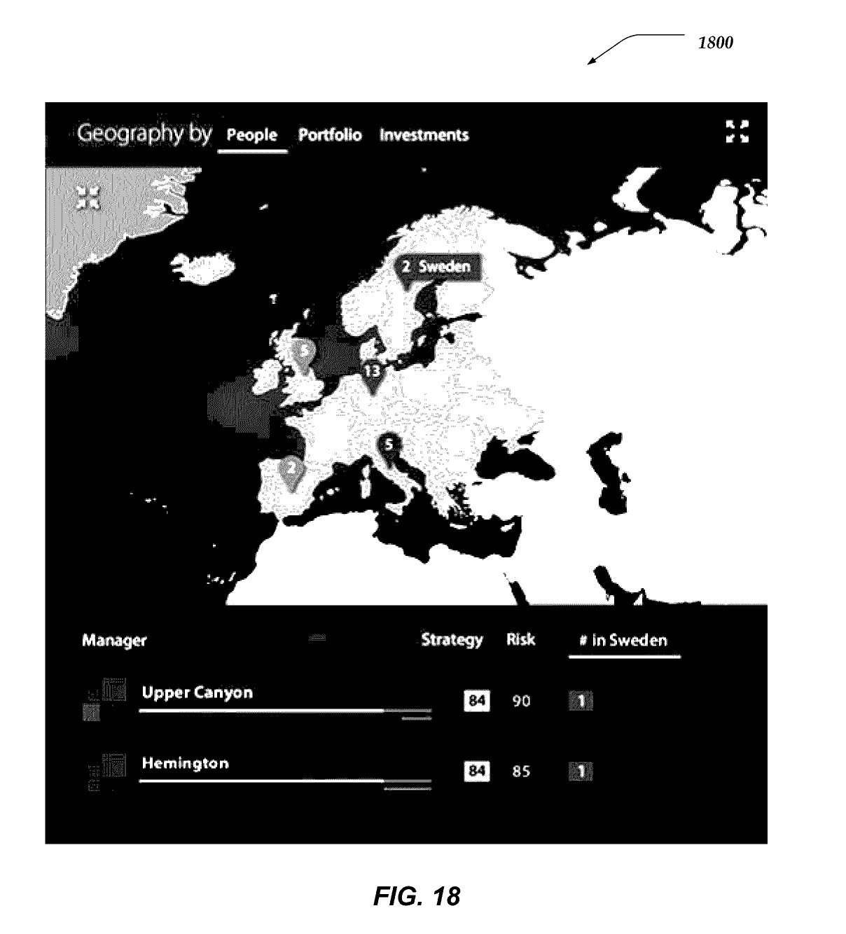

Manager rankings 470 may also show the distribution of the asset classes that each of the funds are invested in. The asset classes may be comprised of one or more of at least five asset classes including real assets, private investments, alternative investments, public equity, and fixed income. As discussed throughout, the distribution of the impact theme and building blocks for each manager may be visually demonstrated via heat maps provided by manager rankings 470. In at least one embodiment, a geography map may be provided that provides a visual representation of the geographies where at least one of the manager's investments are positioned. For instance, FIGS. 17 and 18 shows visual displays (1700 and 1800) that provide impact geography maps that demonstrate the geographical distribution of a fund's impact positions. The maps in visual displays 1700 and 1800 may be color coded to identify developing, emerging, and frontier markets. Furthermore, IPAR 410 generates a plurality of reports 480 that provide a user with updates to the performance and/or metric updates regarding the various funds or managers of funds.

IPAR 410 is a dynamic environment and thus IPAR 410 periodically revisits the impact strategy score and the execution risk score for funds under review to ensure these scores accurately reflect the current approach of the fund or manager. IPAR 410 generates an initial impact strategy score and an initial execution risk score for each fund. With respect to the impact strategy score, the score is adjusted based on the performance of the fund, fund metrics, or fund milestones. The initial execution risk score is increased or lowered as the fund progresses through its lifecycle. For instance, when risked are reduced or wholly eliminated, IPAR 410 actively adjusts the execution risk downward.

IPAR 410 is agnostic and uncompetitive with the numerous measurement tools that exist within the broad impact investment community. For instance, as discussed herein, IPAR 410 incorporates the IRIS taxonomy and GIIRS ratings. By accommodating the plurality of industry metrics and independent measurements, IPAR 410 informs users with a coherent portfolio and fund evaluation that includes independently generated impact strategy scores and execution risk scores.

In some embodiments, IPAR 410 employs geographical information associated with a user to inform the dynamic analysis of the user's impact investing portfolio or fund. In one exemplary embodiment, the user or investor employs a client device that includes a GPS transceiver, such as GPS transceiver 258 of client computer 200 in FIG. 2 or GPS transceiver 368 of network device 300 in FIG. 3. The GPS transceiver provides location information of the user to IPAR 410. Based on the provided location information, IPAR 410 generates various impact investing suggestions for the user. Such suggestions may include impact investing opportunities within a specified proximity to the user's location or environment.

In various embodiments, the user may configure IPAR 410 to employ the location or geographical information in various ways, via user profile parameters or settings. For instance, the user may provide the proximity via a user configurable radius parameter. Upon searching an impact investing database that includes an approximate location about at least a portion of the impact investing opportunities within the database, IPAR 410 generates impact investing opportunities that are located not greater than the user configured radius from the user's location. In this way, IPAR 410 informs or educates the user on local impact investing opportunities. In other embodiments, the user may select to limit the search of the database to within their state (as determined by the GPS provided location information), province, municipality, region, country, or the like.

In a similar way, based on the location information, IPAR 410 may automatically generate an impact invest map, local to the user (or within a user specified range), based on the user's location information. This map may be specific to the user's current portfolio, or may be based on each of the known impact investment instruments that include a presence in the region surrounding the user's location. Such impact geography maps are discussed in at least the context of FIGS. 17 and 18. The maps shown in FIGS. 17 and 18 may be automatically generated based on at least location information of the user.

In addition to location information regarding a user of a client device, IPAR 410 may employ location information from a server device, such as Fund Manager Server 116, Impact Metrics/Taxonomy Server 114, or Portfolio Allocation Review Server 112 of FIG. 1. Such location information may be provided by a GPS transceiver, such as GPS transceiver 368 of network device 300 in FIG. 3. For instance, the location of a fund manager may be used to analyze and/or review the performance, metrics, or milestones of the fund. IPAR 410 may compare the fund or fund manager to other funds of fund managers within a specified range of the fund manager's location. IPAR 410 may suggest various sub-building blocks or possible investment opportunities to the fund manager or user based on a location provided by a network device. In at least one embodiment, IPAR 410 may employ the location of other server devices to inform any of the services IPAR 410 provides users, investors, and fund managers. In a non-limiting exemplary embodiment, the format of various user interfaces, reports, visual displays, heat maps, impact geography maps, and the like may be based on location information of one or more servers that are providing the services of IPAR 410.

In these and other ways, IPAR 410 is enabled to employ location information to inform the dynamic impact investing analysis that may be specific to the user, fund manager, impact metrics, or portfolio reviewer. Thus, the reporting functionality of IPAR 410 provides an enhanced overview of not only global impact investing needs and opportunities, but also the needs and opportunities local to the user. Accordingly, IPAR 410 enables a user to make impact investing decisions that are more consistent and aligned with their overall investing thesis or goals.

As noted throughout, any of the data and/or information regarding IPAR 410 may be structured in one or more data structures and/or sub-data structures. Distributions, such as but not limited to impact theme distributions and building block distributions may be structured as and/or included in portfolio data structures. Each of the components, as discussed herein, included in a distribution may be included in the corresponding data structure. Other information and/or data may be included in one or more data structures. Such information may include at least one of the impact strategy score, impact factor ratings, resource execution risk score, risk ratings, impact milestones, impact performance, and impact performance reports.

### Generalized Operations

The operation of certain aspects of the invention will now be described with respect to FIGS. 5-7. In at least one of various embodiments, processes 500, 600, and 700 described in conjunction with FIGS. 5-7, respectively, or portions of these processes may be implemented by and/or executed on a network computer, such as network computer 300 of FIG. 3. In other embodiments, these processes or portions of these processes may be implemented by and/or executed on a plurality of network computers, such as network computer 300 of FIG. 3. Further, in other embodiments, these processes or portions of these processes may be implemented by and/or executed on one or more mobile computers, such as mobile computer 200 as shown in FIG. 2. Also, in at least one of the various embodiments, these processes or portions of these processes may be implemented by and/or executed on one or more cloud instances operating in one or more cloud networks. However, embodiments are not so limited and various combinations of network computers, client computer, cloud computer, or the like, may be utilized. These processes or portions of these processes may be implemented on any computer of FIG. 1, including, but not limited to user computers 102-108 or any computer included in RM platform 140, such as IPAR 110, MTSC 120, or RMSC 130. These processes or at least portions of these processes may be implemented on or performed by one or more engines, such as but not limited to one or more resource management engines.

FIG. 5 shows an overview flowchart for process 500 for managing one or more resources in accordance with at least one of the various embodiments. The one or more resources may include, but are not otherwise limited to one or more investment investments and/or impact investment metrics In at least one of the various embodiments, process 500 may be employed to manage, quantify, and/or evaluate resource management metrics. In embodiments where the managed resource includes at least impact investments, process 500 is employed to manage, quantify, and/or evaluate impact investment metrics and review the allocation of impact investment portfolios. For instance, process 500 may be employed to generate at least one of portfolio allocation review 460, manager rankings 470, or reporting 480 of FIG. 4.

After a start block, at block 502, a fund impact theme distribution is generated for a fund or a manager of a fund. In various embodiments, the impact theme distribution is based on one or more impact strategies of the fund or the fund manager. For instance, an investment thesis of a fund manager may be broken down, by a percentage basis into thematic components. The various impact strategies of the fund are distributed and/or segmented into a plurality of impact themes. In at least one embodiment, the fund is segmented, by a relative percentage, into four impact themes: Opportunity, Sustainability, Environment, and Public, wherein the relative percentages of the four impact themes sum to 100%. In at least one embodiment, the fund is segmented, by a relative percentage, into four impact themes: People, Resources, Climate, and Public, wherein the relative percentages of the four impact themes sum to 100%. In such embodiments, the People theme may be equivalent to, or at least similar to the Opportunity theme. Likewise, the Resource theme may be equivalent or similar to the Sustainability theme and the Climate theme may be equivalent or similar to the Environment theme. Although in other embodiments, more or less impact themes are employed.

As an exemplary embodiment of an impact theme distribution, FIG. 10 illustrates an interface 1000 that includes a visual display of a heat map of an impact theme distribution for MANAGER_A. MANAGER_A may manage a fund that is evaluated, tracked, and reviewed by IPAR 410 of FIG. 4. Based on MANAGER_A's impact strategies, the impact themes of MANAGER_A are distributed as follows: Opportunity=50%, Sustainability=25%, Environment=25%, and Public=0%. Note that the components of the impact theme distribution sum to 100%. Interface 1000 shows additional information regarding MANAGER_A, such as a summary and highlights of the fund that MANAGER_A manages. Display 1000 also shows an impact strategy score, execution risk, firm score, one or more asset classes and a liquidity status for MANAGER_A. Various managers may provide input, information, and/or data, such as an impact strategy, that is employed to determine the impact theme distribution.

At block 504, a fund or manager building block distribution is generated. The building block distribution may be based on impact strategies of the fund or the manager of the fund. In at least one embodiment, the building block distribution is based on the fund impact theme distribution. Similar to the impact theme distribution, the components of the building block distribution sum to 100%. Each of the components of the impact theme distribution includes one or more building blocks. Each of the theme distribution components may include four building blocks. In at least one embodiment, the four building blocks of the Opportunity impact theme component include Equality, Infrastructure, Services, and Finance. The Sustainability impact theme includes the four building blocks Conservation, Production, Property, and Rehabilitation. The Environment impact theme includes Efficiency, Emissions, Energy, and Waste building blocks. The Public impact theme includes Scoring, Engagement, Mandate, and Alignment building blocks.

Visual display 1000 of FIG. 10 shows a heat map for the building block distribution for MANAGER A, where 50% of MANAGER_A's fund is associated with the Finance building block, 10% in the Production building block, 15% in the Rehabilitation building block, and 25% into the Energy building block. Also shown in visual display 1000 are the sub-building blocks for the impact and building blocks distribution. Sub-building blocks are increasingly descriptive sub-components that further delineate the impact strategy of a fund or a manager of a fund. In various embodiments, sub-blocks may be limitless, provided there is a unit of measure that enables a measure of performance evaluation and data aggregation.

MANAGER_A may provide at least a portion of the sub-building blocks for each of the building blocks. As shown in FIG. 10, MANAGER_A has provided two sub-building blocks (Loans and Small and Medium Sized Enterprises (SME) Capital) associated with the Finance building block under the Opportunity theme. Likewise, the Crops and Fair Trade sub-building blocks are associated with the Production building block. The Rehabilitation building block includes Land and Water sub-building blocks and the Energy building block includes Wind, Solar, and Biomass building blocks.

At block 506, a fund impact strategy score is generated. FIG. 6 shows one embodiment of a process 600 that is operative to generate a fund or fund manager impact strategy score. However, briefly, the impact strategy score is based on the building block distribution. Furthermore, the impact strategy score is based on one or more impact factor ratings for each of the impact themes. In at least one embodiment, the impact strategy score is based on impact factor ratings for each of the building blocks for each of the impact themes. As discussed above, one or more visual displays for the manager or fund, such as interface 1000 of FIG. 10 may show the value of the generated impact strategy score.

At block 508, a fund execution risk score is generated. FIG. 7 shows one embodiment of a process 700 that is operative to generate a fund or fund manager execution risk score. Briefly, the execution risk score is based on the building block distribution. Furthermore, the execution risk score is based on one or more risk ratings for each of the impact themes. In at least one embodiment, the execution risk score is based on risk ratings for each of the building blocks for each of the impact themes. As discussed above, a visual display for the manager or fund, such as visual display 1000 of FIG. 10 may show the value the generated execution risk score.

At block 510, one or more impact milestones for the fund or manager are determined. The milestones may be determined based on the fund's impact performance. At least one of the managers from the plurality of managers 430 of FIG. 4 may provide milestones, updates or status of milestones, and/or roadmaps for a fund. Visual display 1300 of FIG. 13 shows a visual representation of the milestones and/or roadmaps for MANAGER_A. The milestones may be tabulated and/or summarized by year and/or quarter. Each milestone may be characterized as Accomplished, Incomplete, Remaining, and the like.

At decision block 512, it is determined if the execution risk score requires updating based on the milestones determined and/or updated at block 510. If the execution risk score is required to be updated, flow of process 500 proceeds to block 508. Otherwise, the flow of process 500 proceeds to block 514. For instance, if a previously Incomplete or Remaining milestone is determined as accomplished at block 510, the execution risk score may be updated to a lower value by proceeding to block 508. Accordingly, in various embodiments, the execution risk score for a particular fund or manager tends to decrease as the fund accomplishes various milestones. If a milestone remains as Incomplete at block 510, the execution risk score may be updated to a higher value by proceeding to block 508. Accordingly, a fund's milestones may drive, or at least inform, the execution risk score. In at least one embodiment, in instances of extraordinary fund performance or the accomplishment of numerous milestones, process 500 loops back to block 506, so that the impact strategy score may be updated to reflect the increased performance of the fund.

At block 514, one or more impact metrics for the fund or manager of the fund are determined. The metrics may include any industry metrics, including but not limited to IRIS, HIPS, GIIRS, B Impact Assessment, PULSE metrics, and the like. Interface 1400 of FIG. 14 shows a visual representation of the milestones and/or roadmaps for MANAGER_A. For instance, visual display 1400 shows a plurality of IRIS metrics for MANAGER_A. In at least one embodiment, the manager of a fund may provide at least a portion of the determined metrics. Some of the metrics may be provided by a third party.

At decision block 516, it is determined if the impact strategy score requires updating based on at least one of the impact metrics determined and/or updated at block 514 or the impact milestone determined and/or updated at block 510. If the impact strategy score is required to be updated, flow of process 500 proceeds to block 506. Otherwise, the flow of process 500 proceeds to block 518. In various embodiments, if a metric is determined to be significantly greater than expected or a previously determined milestone, then the impact strategy score may be updated to a greater value by proceeding to block 506. Accordingly, in various embodiments, the impact strategy score for a particular fund or manager tends to increase (or decrease) as the fund's metrics increase (or decrease). Accordingly, a fund's metrics may drive, or at least inform, the impact strategy score. In at least one embodiment, based on the determined milestones of block 510, process 500 loops back to block 508, so that the execution risk score may be updated to reflect the evolution of the fund's metrics over time. Accordingly, IPAR is a dynamic system that tracks the evolution of both a fund's impact strategy score and the execution score based on the fund's performance, metrics, and milestones over time.

At block 518, a firm score for the fund is determined. The firm score is separate from both the impact strategy score and the execution risk score. In various embodiments, the firm score is based on a firm questionnaire. The questionnaire provides insight into critical areas of the fund's sustainable, impact-driven business management. The questionnaire may be focused on various impact topics and areas such as Governance, Workers, Community, Environment, Field Building, and the like. Accordingly, in various embodiments, the firm score includes sub-firm scores in topics such as Governance, Workers, Community, Environment, and Field Building, as well as an overall firm score. Interface 1400 of FIG. 14 shows scores in impact areas or topics of Governance, Workers, Community, Environment, Field Building, as well an overall Firm Score and a GIIRS impact rating for MANAGER_A.

At block 520, one or more fund impact performance reports are generated for the fund. The generated reports are based one or more of the generated fund impact strategy score, the generated/updated execution risk, or the determined impact milestones. The one or more reports may include any of interfaces 800, 900, 1000, 1100, 1200, 1300, 1400, or 1500 of FIG. 8, 9, 10, 11, 12, 13, 14, or 15 respectively. Furthermore, the reports may include any information provided by these various interfaces in different configurations or visual displays thereof.

### Impact Strategy Scores

FIG. 6 shows an overview flowchart for process 600 that is operative for generating an impact strategy score for a resource or resource manager in accordance with at least one of the various embodiments. The resource may be, but is not otherwise limited to various impact investing instruments, such an impact fund. An impact strategy score includes a single number or value that reflects the overall actual or potential impact of the various impact strategies implemented by a particular fund. In some embodiments, the impact strategy score is normalized, such that the impact score is between 0 and 100. Although other embodiments are not so constrained and the impact strategy score may take on values outside of this range.

Briefly, a fund with a relatively high impact score is focused on or otherwise pursues or attempts to obtain, to varying degrees, at least three social objectives: Target, Scalability, and Innovation. The Scalability objective or factor refers to the ability to beneficially impact a large number of people. The Target factor refers to benefiting a geography or population that is exposed to ingrained or chronic issues. The Innovation factor refers to producing a creative or unique solution to a seemingly intractable issue or problem. Generally, the greater the Target, Scalability, and Innovation objectives of a fund's targeted investments, the higher the fund's impact strategy score. Because in some embodiments the score is normalized, the impact strategy score enables a coherent comparison amongst a plurality of funds or fund managers, depending upon an investor's impact thesis or overall strategy.

As discussed further below, impact strategy scores are based on one or more impact factor ratings. In some embodiments, one or more impact factor ratings are associated with each impact theme of a fund's impact theme distribution. In at least one embodiment, a plurality of impact factor ratings are associated with each building block of a fund's building block distribution. In at least one embodiment, each building block or impact theme is associated with three impact factor ratings: Target, Scalability, and Innovation. For instance, each of the four impact themes may receive three separate and independent impact factor ratings, one for each of Target, Scalability, and Innovation. In at least one embodiment, each of the building blocks may receive the three separate and independent impact factor ratings.

Each of these impact factor ratings are quantifications of and reflect the fund objectives regarding Target, Scalability, and Innovation as discussed above. Each impact factor rating may include a numerical factor between 0.0 and 5.0 to provide a subjective or objective criteria of the manger's approach to impact investing. In at least one embodiment, the impact factor ratings may be quantified via stars, for instance 4 out of 5 stars. Generally, the higher the impact factor rating, the more concentrated that manager's impact strategy is in regard to the particular factor. For impact themes, or building blocks under a particular theme, where the manager has no associated holdings or strategies, the corresponding impact factor rating is equivalent or near 0.0. Accordingly, these impact themes or building blocks do not contribute to the overall impact strategy score for a manager that is not deploying capital or otherwise focusing on such objectives.

After a start block, at block 602, the sub-building blocks for the building block distribution of the fund are determined. The sub-building blocks are increasingly descriptive sub-components of the building blocks and may be limitless in number and/or descriptions. For instance, interface 1000 of FIG. 10 provides a heat map for the impact theme distribution and the building block distribution of MANAGER_A. As shown, MANAGER_A's building block distributions includes sub-building blocks Loans, SME Capital, Crops, Fair Trade, Land, Water, Wind, Solar, and Biomass, under various building blocks. In some embodiments, a manager may provide at least some of the sub-building blocks for the building block distribution of the manager.

At block 604, one or more Target impact factor ratings are determined for building blocks or impact themes of the fund under review. The Target impact factor ratings may be based on at least one of a fund performance, one or more fund milestones, or one or more fund metrics. The Target impact factor ratings may dynamically be updated and/or varied based on the fund performance, metrics, or milestones. The Target factor ratings may be based on expected or actual Target related impacts of the fund. The Target impact factor rating reflects various conditions of the regions that the fund is actually or expected to impact. For most of the impact themes or building blocks, the potential for social and/or environmental benefit typically increases as the per capital income level decreases. Funds focused on developed markets and/or citizens of developed markets are associated with a lower Target impact factor rating. One possible exception to this general trend involves the Environmental theme, where technologies focused on reducing carbon emissions in highly industrialized markets may have enormous impact on the entire global population.

Those funds working in international emerging markets, domestic urban or rural areas, or supporting populations thereof are associated with a medium Target impact factor rating. Funds or managers targeting frontier markets and/or people tend to be funds with high Target impact factor ratings. In various embodiments, Target impact factor ratings reflect the likelihood that the affected areas would have otherwise received (in the absence of impact investing) access to financial capital.

As a general guideline, a Target impact factor rating of approximately or near 1 reflects or is otherwise indicative of an expected or actual impact targeted at a developed market and/or that market's citizens. Accordingly, a low Target impact factor rating implies a high likelihood that the target would receive financial capital, without the need for impact investing. Likewise, a Target impact factor rating of approximately 2 refers to funds investing in international markets skewing toward developed nations and their citizens. A Target factor rating of 3 reflects an expected or actual impact in a domestic urban or rural area or the citizens of an emerging market, a rating of 4 implies an impact in an international market skewing toward emerging markets or their citizens, and a rating of 5 refers to an expected or actual impact in a frontier market. Thus, higher Target impact ratings are associated with funds that provide capital to markets with little to no likelihood of receiving financial capital but for impact investing.

At block 606, one or more Scalability impact factor ratings are determined for building blocks or themes of the fund under review. The Scalability impact factor ratings may be based on at least one of a fund performance, one or more fund milestones, or one or more fund metrics. The Scalability impact factor ratings may dynamically be updated and/or varied based on the fund performance, metrics, or milestones. The Scalability factor ratings may be based on expected or actual Scalability related impacts of the fund. The Scalability impact factor rating reflects the likelihood that the associated impact theme or building block strategy will be adopted on a broad level to expand the intended impact. As a general guideline, a Scalability impact factor rating of approximately or near 1 reflects an expected or actual impact at a city or specific group level. Likewise, a Scalability impact factor rating of approximately 2 refers to an expected or actual impact at the region or segmented community level. A Scalability factor rating of 3 reflects an expected or actual impact at a county or broad population level, a rating of 4 implies an impact at the multination or international society level, and 5 refers to an expected or actual impact at a worldwide or global citizenry level. Other embodiments may include other scoring systems or values.

At block 608, one or more Innovation impact factor ratings are determined for building blocks or themes of the fund under review. The Innovation impact factor ratings may be based on at least one of a fund performance, one or more fund milestones, or one or more fund metrics. The Innovations impact factor ratings may dynamically be updated and/or varied based on the fund performance, metrics, or milestones. The Innovation factor ratings may be based on expected or actual Innovation related impacts of the fund. The Innovation impact factor rating rewards managers who focus on investment instruments that deploy creative strategies for confronting problems with creative solutions. As a general guideline, an Innovation impact factor rating of approximately or near 1 reflects a traditional approach to problems. Likewise, an Innovation impact factor rating of approximately 2 refers to adopting minor improvements to traditional approaches to problem solving. An Innovation factor rating of 3 reflects a gradual improvement to problem solving, a rating of 4 implies a unique alteration for solving problems, and 5 refers to a novel breakthrough when it comes to solving problems. Other embodiments may include other scoring systems or values.

Interface 1100 of FIG. 11 shows a visual display of a listing of each of the Target, Scalability, and Innovation impact factor ratings for MANAGER_A. Interface 1100 also shows the impact theme and building block distribution, as well as the sub-building blocks for MANAGER_A. In the embodiment shown in FIG. 11, three impact factor ratings (Target, Scalability and Innovation) are associated with each building block. In other embodiments, three impact factor ratings are associated with each impact theme. In such embodiments, the impact factor associated with the building blocks for a particular theme may be combined or otherwise blended to generate an impact factor ratings representative of the impact theme. Also, note that for building blocks (or impact themes) where the fund or manager does not have any holdings, the impact factors ratings are 0.0.

At block 610, impact strategy weights are determined for each of the impact factor ratings. In various embodiments, the weights reflect the overall importance of the impact factor to the impact thesis. In at least one embodiment, a user may provide the impact strategy weights. For instance, the weights may be based on the impact thesis, impact theme distribution, or building block distribution of a particular impact investor. In this way, the impact strategy score presented to the user reflects the user's impact strategies or thesis.

At block 612, the impact strategy score for the fund or manager is generated. In various embodiments, the impact strategy score is based on the impact factor ratings and impact strategy weights. The impact strategy score may be based on at least one of a fund performance, one or more fund milestones, or one or more fund metrics. The impact strategy score may dynamically be updated and/or varied based on the fund performance, metrics, or milestones. In some embodiments, the impact strategy score is equivalent to the sum-weighted (via the weights determined at block 610) value of each strategy across the impact factor ratings. When the impact factor ratings do not accurately represent the overall strategy of a particular fund, the impact strategy score may be adjusted, based on the structure of the fund and/or other intangibles.

In a generalized embodiment, the impact strategy score (S) may be generated based on the below equation:

$$S = {\sum }_{i = 1}^{n} {\sum }_{j = 1}^{j = {m}_{i}} {\sum }_{k = 1}^{k = {l}_{i , j}} {w}_{i , j , k} * {r}_{i , j , k}$$

where n is the number of impact themes, mᵢ is the number of building blocks for the ith impact theme, lᵢⱼ is the number for impact factor ratings for the jth building block of the ith impact theme, r_{i,j,k} is the value for the kth impact factor rating for the jth building block of the ith theme, and w_{i,j,k} is the impact strategy weight for the r_{i,j,k}. As discussed above, in various embodiments, n=4, mᵢ=4, and l_{i,j}=3. However, it should be noted that other computational schemes are possible, and the generation of an impact strategy score may be generalized to that shown in the above equation.

Interface 1100 of FIG. 11 displays each of r_{i,j,k} for MANAGER_A. The resulting impact score (S) for MANAGER_A is 84.0 In various embodiments, based on the performance of the fund, the impact strategy score may be updated. For instance, in instances of extraordinary fund performance or the accomplishment of numerous milestones, the impact strategy score may be updated to reflect the increased performance of the fund.

At decision block 614, in at least one of the various embodiments, it is determined if the metrics of the fund have been updated. If the metrics have been updated, process 600 proceeds to block 604 so that the impact strategy score may be updated in view of the updated metric status. As discussed throughout, the impact strategy score is informed by at least the metrics of the fund. In at least one embodiment, if a fund performance or one or more milestones of the fund is updated, process 600 proceeds to block 604 so that the impact strategy score may be updated. Otherwise, control may be returned to a calling process

### Execution Risk Scores

FIG. 7 shows an overview flowchart for process 700 that is operative for generating an execution risk score for a resource or resource manager in accordance with at least one of the various embodiments. The resource may include, but is not otherwise limited to an impact investment instrument, such as an impact fund. An execution risk score includes a single number or value that reflects the overall actual or potential execution risk of the various impact strategies implemented by a particular fund. In some embodiments, the execution risk score is normalized, such that the execution risk score is between 0 and 100. Although other embodiments are not so constrained and the execution risk score may take on values outside of this range.

The execution risk score is based on the investment's ability or likelihood to achieve the stated social and/or environmental benefits. Financial considerations factor into the generations of the execution risk score, the execution score is separate and/or independent of the fund's return expectation or implied financial volatility. As discussed herein, the execution risk score is informed by at least the milestones of the fund.

After a start block, at block 702, one or more impact strategy risk ratings are determined for building blocks or themes of the fund under review. For instance, each of the four impact themes may receive a separate and independent impact strategy risk rating. In at least one embodiment, each of the building blocks may receive a separate and independent impact strategy risk rating.

The impact strategy risk rating may be based on expected or actual risks intrinsically associated with the execution of each individual strategy, impact theme, or building block of the fund. In some embodiments, the impact strategy risk rating may be based on at least one of a fund performance, metrics, or milestones. In at least one embodiment, each impact strategy risk rating includes a numerical factor between 0.0 and 5.0 to provide a subjective or objective criteria for the execution risk of the manger's approach to impact investing. In at least one embodiment, the impact strategy risk rating may be quantified via stars, for instance 2 out of 5 stars. In general, the higher the impact strategy risk rating, the riskier the manager's impact strategy is in regards to actual execution. For impact themes, or building blocks under a particular theme, where the manager has no associated holdings or strategies, the corresponding impact strategy risk rating is equivalent or near 0.0. Accordingly, these impact themes or building blocks do not contribute to the overall execution risk score for a manager that is not deploying capital to such objectives.

At block 704, one or more exogenous risk ratings are determined for building blocks or themes of the fund under review. For instance, each of the four impact themes may receive a separate and independent exogenous risk rating. In at least one embodiment, each of the building blocks may receive a separate and independent exogenous risk rating. The exogenous risk rating may be based on expected or actual exogenous or external risks associated with the execution of each individual strategy, impact theme, or building block of the fund. In some embodiments, the exogenous risk rating may be based on at least one of a fund performance, metrics, or milestones.

At block 706, one or more operational risk ratings are determined for building blocks or themes of the fund under review. For instance, each of the four impact themes may receive a separate and independent operational risk rating. In at least one embodiment, each of the building blocks may receive a separate and independent operational risk rating. The operational risk rating may be based on expected or actual operational risks associated with the execution of each individual strategy, impact theme, or building block of the fund. In some embodiments, the operational risk rating may be based on at least one of a fund performance, metrics, or milestones

One or more of the impact strategy, exogenous, or operational risk ratings may be based on the performance or metrics. of the fund. In various embodiments, at least a portion of the risk ratings are based on the milestones or one or more roadmaps for the fund. Interface 1300 of FIG. 13 shows milestones for MANAGER_A. Various milestones for a fund may be characterized as Accomplished, Incomplete, Remaining, or the like depending upon the performance, progress, or status of the fund. For instance, when a milestone is reached such that the milestone is Accomplished, a risk rating associated with that milestone may be reduced. Likewise, if a milestone was originally scheduled to be Accomplished by a given target date, but remains Incomplete after the target date, a risk rating associated with the milestone may be increased to reflect the increased risk of execution.

Interface 1200 of FIG. 12 shows a visual display of a listing of each impact strategy, exogenous and operational risk ratings for MANAGER_A. Interface 1200 also shows the impact theme and building block distribution, as well as the sub-building blocks for MANAGER_A. Note in the embodiment shown in FIG. 12, an independent impact strategy, exogenous, and operational risk rating is associated with each building block. In other embodiments, an independent impact strategy, exogenous and operational risk rating is associated with each impact theme. In such embodiments, the risk ratings associated with the building blocks for a particular theme may be combined or otherwise blended to generate a risk rating representative of the impact theme. Also, note that for building blocks (or impact themes) where the fund or manager does not have any holdings, the risk rating is 0.0.

At block 704, risk weights are determined for each of the risk ratings. In various embodiments, the weights reflect the overall importance of the risk rating to the impact thesis. In at least one embodiment, a user may provide the risk weights. For instance, the risk weights may be based on the impact thesis, impact theme distribution, or building block distribution of a particular impact investor. In at least one embodiment, the risk weights may be equivalent or similar to the impact strategy weights determined at block 610 of FIG. 6.

At block 706, the execution risk score for the fund or manager is generated. In various embodiments, the execution risk score is based on the risk ratings and risk weights. In various embodiments, the execution score score is equivalent to the sum-weighted value of each of the risk ratings. The execution risk score may be adjusted based on the risks that are exogenous to the effective implementation of the impact thesis.

In a generalized embodiment, the execution risk score (R) may be generated based on the below equation:

$$R = {\sum }_{i = 1}^{n} {\sum }_{j = 1}^{j = {m}_{i}} {\sum }_{k = 1}^{k = {l}_{i , j}} {w}_{i , j , k} * {r}_{i , j , k}$$

where n is the number of impact themes, mᵢ is the number of building blocks for the ith impact theme, l_{i,j} is the number for execution ratings for the jth building block of the ith impact theme, r_{i,j,k} is the value for the kth execution factor rating for the jth building block of the ith theme, and w_{i,j,k} is the execution weight for the r_{i,j,k}. As discussed above, in some embodiments, n=4, mᵢ=4, and l_{i,j}=3. However, it should be noted that other computational schemes are possible, and the generation of an execution score may be generalized to that shown in the above equation.

Note that the generation of the impact strategy score, as is described in the context of at least FIG. 6 is independent from the generation of the execution risk score. However, in various embodiments, a higher execution risk score may be indicative of a higher impact strategy score for a fund. Execution risks are inherent to performance in each of the three impact factor ratings. Thus, rarely will a high-scoring impact strategy be associated with a fund that has a low execution risk score.

The inverse relationship, i.e. a low impact score implies a low execution risk score need not be true. Strategies that aim to affect small populations (low Scalability impact rating factor) of privileged citizens (low Target impact factor rating) with a traditional investment approach (low Innovation impact factor rating) are likely to receive a low impact strategy score. However, such an impact investment thesis, while lacking in significant impact potential, may still carry a high execution risk potential.

At decision block 708, in at least one of the various embodiments, it is determined if the milestones of the fund have been updated. If the milestones have been updated, process 700 proceeds to block 702 so that the execution risk score may be updated in view of the updated milestone status. As discussed throughout, the risk execution score is informed by at least the milestones of a fund. In at least one embodiment, if a fund performance or one or more metrics of the fund is updated, process 700 proceeds to block 702 so that the execution risk score may be updated. Otherwise, control may be returned to a calling process.

### Illustrative Use Cases

FIGS. 8-15 represent various dynamic graphical user interfaces and visual displays of an Impact Portfolio Allocation Reviewer, such as IPAR 410 of FIG. 4. In at least one of the various embodiments, user interfaces and/or displays other than those shown in FIGS. 8-15 may be employed without departing from the spirit and/or scope of the claimed subject matter. Such user interfaces may have more or fewer user interface elements which may be arranged in various ways. In some embodiments, user interfaces may be generated using web pages, mobile applications, or the like. In at least one of the various embodiments, resource management client 220 of FIG. 2 and/or resource management server 360 of FIG. 3 may include processes and/or API for generating such user interfaces and/or visual displays. At least one of resource management client 220 or resource management server 360 may include, or communicate with, at least portions of a resource management engine.

FIG. 8A shows a visual display 800 of a portfolio impact theme and building block heat map for impact investing PORTFOLIO_A. In various embodiments, IPAR 410 may determine at least one of the impact theme distribution of the building block distribution based on an evaluation of PORTFOLIO_A. For instance, IPAR 410 may determine the impact theme distribution and/or the building block distribution for each of the funds or managers of funds held within PORTFOLIO_A. IPAR 410 may determine the distributions for PORTFOLIO_A by distributing each of the distributions of the managers or funds held within PORTFOLIO_A based on the proportional or relative holdings with PORTFOLIO_A for each manger or fund. In various embodiments, a user of IPAR 410 may provide a desired theme and building block distribution via a client device, such as Client Device 200 of FIG. 2.

As discussed throughout, the distributions shown in FIG. 8A may be configured and arranged in one or more data structures and/or databases. For instance, the building block distributions may be included in one or more portfolio data structures. Similarly, the impact theme distributions may be included in one or more portfolio data structures.

As shown in interface 800, the theme and building block distributions of PORTFOLIO_A are represented via heat maps. PORTFOLIO_A is distributed into four impact themes with the following relative concentrations: Opportunity=25%, Sustainability=40%, Environment=15%, and Public=20%. Furthermore, each of the components of the impact theme distribution 800 is further segmented into a building block distribution. Within the Opportunity theme, the impact thesis is segmented into Infrastructure (13%) and Services (12%) building blocks. Note that the building block distribution components, under the Opportunity theme (Equality, Infrastructure, Services, and Finance) sum to 25% because PORTFOLIO_A's impact theme distribution Opportunity component is 25%. The Sustainability theme is segmented into a building block distribution of: Conservation=10%, Production=5%, Property=7%, and Rehabilitation=18%. The remaining building block distribution of PORTFOLIO_A is shown in FIG. 8A.

FIG. 8B shows another embodiment of a visual display 850 of a portfolio impact theme and building block heat map for impact investing PORTFOLIO_A. In the embodiment shown in FIG. 8B, PORTFOLIO_A is distributed into four impact themes with the following relative concentrations: People=25%, Resources=40%, Climate=15%, and Public=20%. Furthermore, each of the components of the impact theme distribution 850 is further segmented into a building block distribution. Within the People theme, the impact thesis is segmented into Employment (13%) and Access (12%) building blocks. Note that the building block distribution components, under the People theme (Equality, Employment, Access, and Finance) sum to 25% because PORTFOLIO_A's impact theme distribution People component is 25%. The Resources theme is segmented into a building block distribution of: Conservation=10%, Production=5%, Reduction=7%, and Rehabilitation=18%. The remaining building block distribution of PORTFOLIO_A is shown in FIG. 8B. Note the equivalence and/or similarly between the Opportunity and People themes of FIGS. 8A and 8B, respectively. Note the equivalence and/or similarly between the Sustainability and Resources themes of FIGS. 8A and 8B, respectively. Further note the equivalence and/or similarly between the Environment and Climate themes of FIGS. 8A and 8B, respectively. Also note the equivalence and/or similarity of the corresponding building blocks in each of the themes for FIGS. 8A and 8B.

As discussed throughout, the distributions shown in FIG. 8B may be configured and arranged in one or more data structures and/or databases. For instance, the building block distributions may be included in one or more portfolio data structures. Similarly, the impact theme distributions may be included in one or more portfolio data structures.

FIG. 8C shows an embodiment of portfolio data structure 860 that comprises records that include Identifiers (ID), category types, category weight fields, parent ID fields, and customer ID fields. The arrangement and configuration of a memory to include the exemplary portfolio data structure provides for a faster and more efficient generation of a visual display of a portfolio impact theme and a building block heat map for a different customers. Also, the portfolio data structure is an improvement over previous data structures and databases that employ data schemas having various linked tables and/or linked lists to store, search, and retrieve records. In one or more embodiments, the exemplary portfolio data structure is employed with a self-referential database to provide improved speed and efficiency in the storing, searching, and retrieval of information from records in the self-referential database.

FIG. 16 shows a screen clipping of an interface of a visual display 1600 of a portfolio impact theme and building block heat map that employs relative sizes and colors to demonstrate details of the distributions. Visual display 1600 conveys similar information to visual display 800. However, in visual display 1600, the icons representing the building blocks are relatively sized to visually represent the relative size of the components of the impact theme and building block distributions. Also note, colors are used to visually identify the themes. In visual display 1600, each of the Opportunity building block icons are colored yellow, each of the Sustainability building block icons are colored red, each of the Environment building block icons are colored green, and each of the Public building block icons are colored purple. Other colors may be used. Also, note that relative arrangement, off-setting, and “popping out” effects for the building block icons for components that are significantly non-zero. Thus, visual display 1600 provides a distinct and unique visual cue or identifier for the manager. Note that the Secondary theme in visual display 1600 may be referred to as a Public theme in some embodiments.

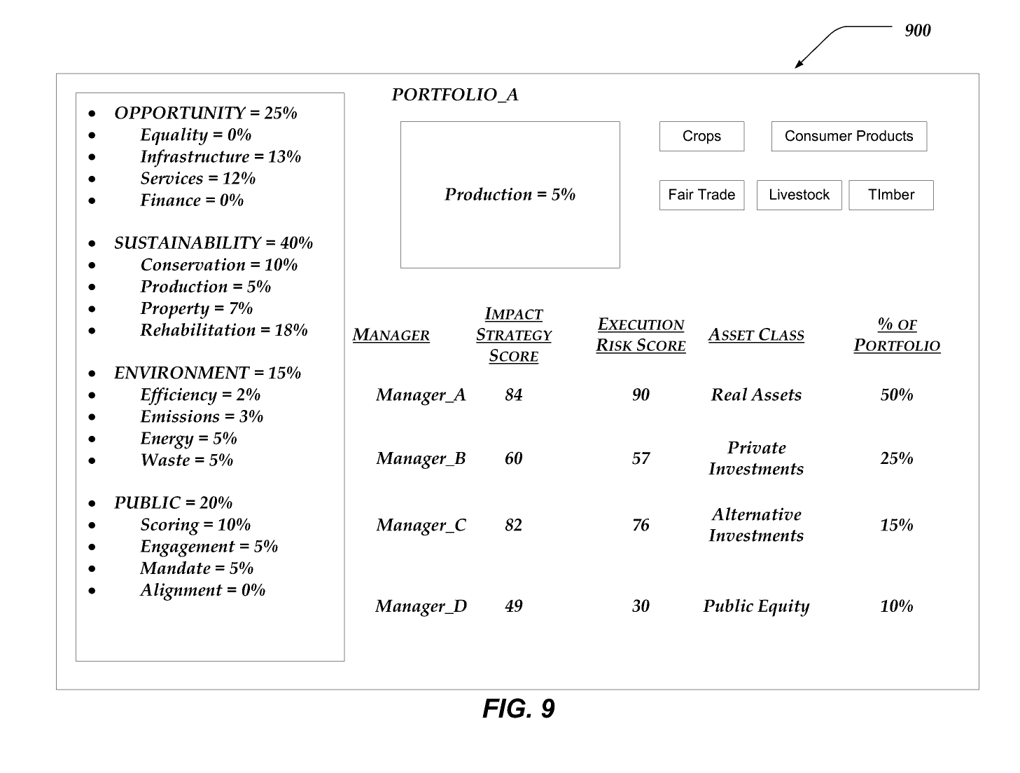

When a user clicks or otherwise selects an impact theme or building block, in either visual display 800 or 1600, IPAR may provide additional information or reports regarding the selected theme or building block. For instance, a user may select the Production building block and be provided with visual display or interface 900 of FIG. 9. FIG. 9 illustrates an interface 900 providing detailed information regarding the Production building block within PORTFOLIO_A's building block distribution. Interface 900 includes a listing of both the impact theme distribution and the building block distribution. Interface 900 also provides a listing of each of the managers or funds that PORTFOLIO_A is invested in and the relative proportion of each of the funds' or managers' Production building block component with PORTFOLIO_A. The impact strategy score, execution risk score, and asset classes for each of the listed funds is also shown in interface 900.

Interface 900 also shows the sub-building blocks for the Production building block component of PORTFOLIO_A. For instance, 5% of PORTFOLIO_A's holdings are concentrated in Production, and specifically within the sub-building blocks of Crops, Consumer Products, Fair Trade, Livestock, and Timber, as indicated by the various fund managers that held by PORTFOLIO_A. Furthermore, 50% of the Production 5% of PORTFOLIO_A is held by MANAGER_A, 25% is held by MANAGER_B, 15% is held by MANAGER_C, and 10% is held by MANAGER_D.

When a user selects one of the managers within PORTFOLIO_A, IPAR provides detailed information regarding the selected manager. If a user were to select one of MANAGER_A, MANAGER_B, MANAGER_C, or MANAGER_D in interface 900, in various embodiments, IPAR would provide a report, sub-report, or one or more interfaces detailing the selected manager. For instance, when a user selects MANAGER_A in interface 900, IPAR provides one or more interfaces 1000, 1100, 1200, 1300, Or 1400 of FIG. 11, 12, 13, or 14, which provide the user detailed information regarding MANAGER_A.

FIG. 10 shows an interface 1000 that provides the impact theme and building block heat maps for a MANAGER_A. Interface 1000 also provides summary and highlight information for MANAGER_A. Interface 1000 further shows the impact strategy score, execution risk, firm score, asset classes, liquidity status, as well as other information regarding MANAGER_A's fund.

FIG. 11 shows an interface 1100 that provides the Target, Scalability, and Innovation impact factor ratings, as well as the impact strategy score for MANAGER_A. As described in at least the context of FIG. 6, these impact factor ratings are employed to generate the impact strategy score for MANAGER_A. Interface 1100 also shows the impact theme distribution and building block distribution generated for MANAGER_A, as well as the sub-building blocks provided by MANAGER_A.

FIG. 12 shows an interface 1200 that provides risk ratings, as well as the execution risk score for MANAGER_A. As described in at least the context of FIG. 7, these risk ratings are employed to generate the execution risk score for MANAGER_A. Interface 1200 also shows the impact theme and building block distribution, as well as the sub-building blocks for MANAGER_A.

FIG. 13 shows an interface 1300 that provides a roadmap, milestones, and status of various milestone for MANAGER_A. Interface 1300 provides a graphical representation of milestones on a quarter-by quarter-basis and also annual reviews. Furthermore, the status of each milestone may be shown in interface 1300. For instance, based on the performance of the fund, the status of each of the milestones may be characterized as Accomplished, Incomplete, Remaining, and the like.

FIG. 14 shows an interface 1400 that provides impact metrics, firm scores, and an impact rating for MANAGER_A. Interface 1400 provides a graphical representation for several impact metrics for the fund managed by MANAGER_A. In various embodiments, these metrics include at least one of IRIS metrics, B Impact Assessment metrics, GIIRS metrics, HIPS metrics, SROI metrics, PULSE metrics, or any other impact metric. Furthermore, interface 400 provides various firm scores for impact areas, such as Governance, Workers, Community, Environment, Field Building, and the like. An overall firm score is also provided by interface 1400, as well as a GIIRS rating.

For funds where a GIIRS rating may not be available, a synthetic rating may be generated as a proxy for a GIIRS rating. A questionnaire may be deployed to the manager of a fund, where the questionnaire is similar to the questionnaire employed to generate a synthetic GIIRS rating. As with the GIIRS rating, the synthetic rating provides the user with a sense of the manager's commitment to impact. The GIIRS rating or the synthetic GIIRS rating are separate and independent from each of the impact strategy score and the execution risk score.

IPAR also provides ranked listing of the various fund managers under review. FIG. 15 shows an interface 1500 that provides a listing and a ranking of mangers of funds based on at least one of an impact strategy score, an execution risk score, and an asset class associated with the manager. The listed managers may be ranked by their associated impact score, execution risk score, firm score, GIIRS rating, and the like. A particular user may filter the ranked list to illustrate only those managers currently held by the user's impact portfolio, those under consideration for future investment, or any other such filtering criteria. Upon selecting one of the managers in the list shown in interface 1500, IPAR may provide any interface similar to interfaces 1000, 1100, 1200, 1300, or 1400 of FIG. 11, 12, 13, or 14, for the selected manager.

FIG. 17 shows a screen clipping of an interface of a visual display 1700 that demonstrates an impact geography of a fund. In addition to summarizing a fund via themes, building blocks, and sub-building blocks, in various embodiments, a fund is summarized via geography. Visual display 1700 shows a global map that summarizes, via color coding the distribution of impacts of a fund.

The world map of visual display 1700 may be broken out and/or color-coded via markets; for instance by developing, emerging, and frontier markets. The map also indicates where there are “boots on the ground” associated with the various activities of the fund, how a user's or manager's portfolio is broken down, and where the investments are being made. FIG. 18 shows a screen clipping of an interface of a visual display 1800 that demonstrates a zoomed in view, viewing clicking, of impact geography of a fund. Visual display 1800 shows a zoomed in view of the Eurasia and North African region. The maps shown in visual displays 1700 and 1800 may be generated based on at least location information provided by a GPS transceiver, such as GPS transceiver 258 of client device 200 in FIG. 2. Visual display 1800 shows the impact geography for two fictional funds: Upper Canyon and Hemington.

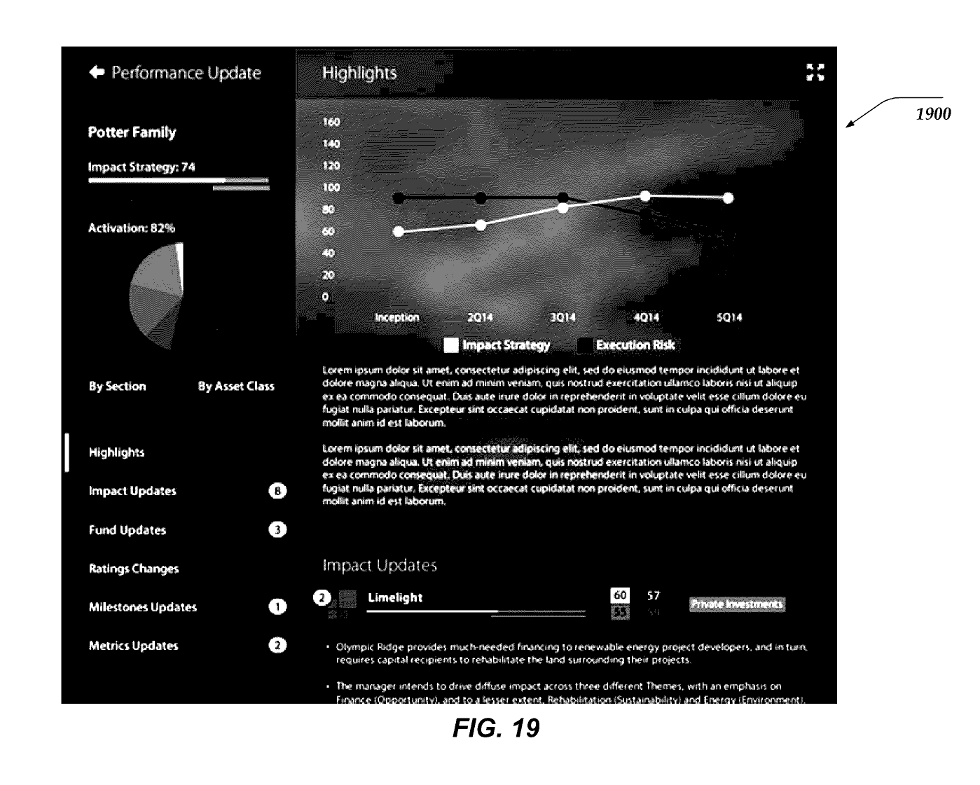

FIG. 19 shows a screen clipping of an interface of a visual display 1900 that demonstrates the dynamic nature of the analysis and reporting features of the various embodiments described herein. As discussed throughout, the milestones, metrics, impact strategy score, execution and other portfolio- or fund-specific information and/or analyses is updated over time based on the performance of the fund or portfolio. As shown in visual display 1900, the evolution of both the impact strategy score and the execution risk score is shown as a function of time. The review may be shown at the portfolio or fund level.

In various embodiments, a “playback function” is provided to review the impact performance. Such a review function may be shown at the section or asset class level. In addition, the total or relative number of updates for each reported on category may be shown. For instance, a heat map playback feature may “animate” the evolution of a portfolio's or fund's impact investment heat map. In at least one embodiment, alerts may be provided to a user to notify that an update associated with their fund or portfolio has occurred. The reporting may be broken out on a quarterly basis. Thus, a user may review all updates filtered on impact, milestones, metrics, score updates, managers, and the like.

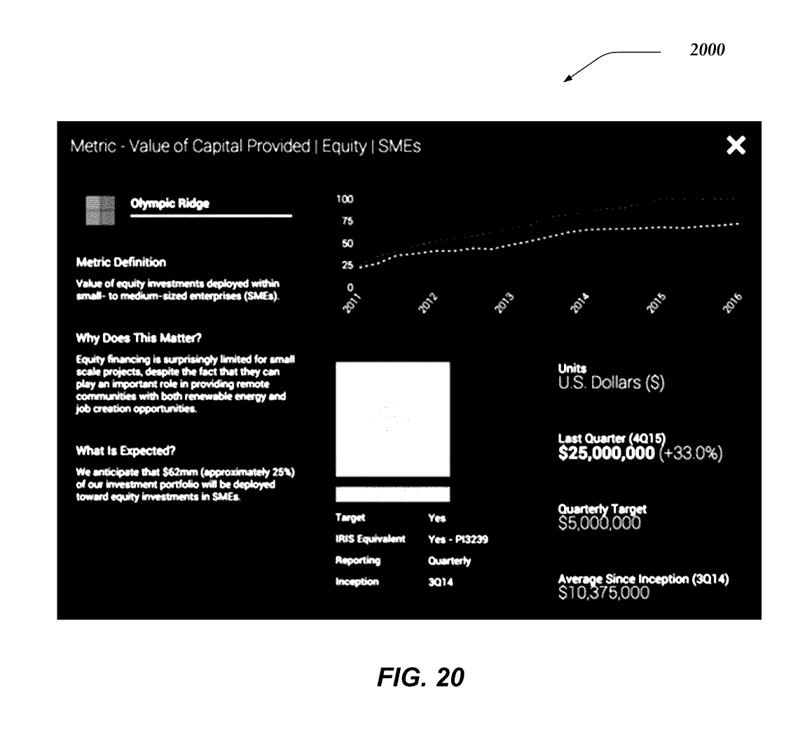

FIG. 20 shows a screen clipping of an interface that provides a metric modal 2000 that is consistent with the various embodiments described herein. Metric modal 2000 shows a plurality of information that provides contextualizes a metric tracked within IPAR. A separate metric modal may be included for at least a portion of the metrics that are tracked within IPAR. As shown in FIG. 20, metric modal 2000 provides contextualizing information regarding the “Value of Captial Provided by Equity Small and Medium Sized Enterprises (SMEs).” Modal metrics for other metric may include similar information. The information may be provided by one or more fund managers that are reporting and/or investors regarding the metric. As shown in metric modal 2000, various embodiments of a metric modal may provide one or more of a metric definition, a context for why the metric matters, and a future expectation for the metrics. The metric modal may provide additional information, such as but not limited to various investment data, and a plot of the metric's value as a function of time.

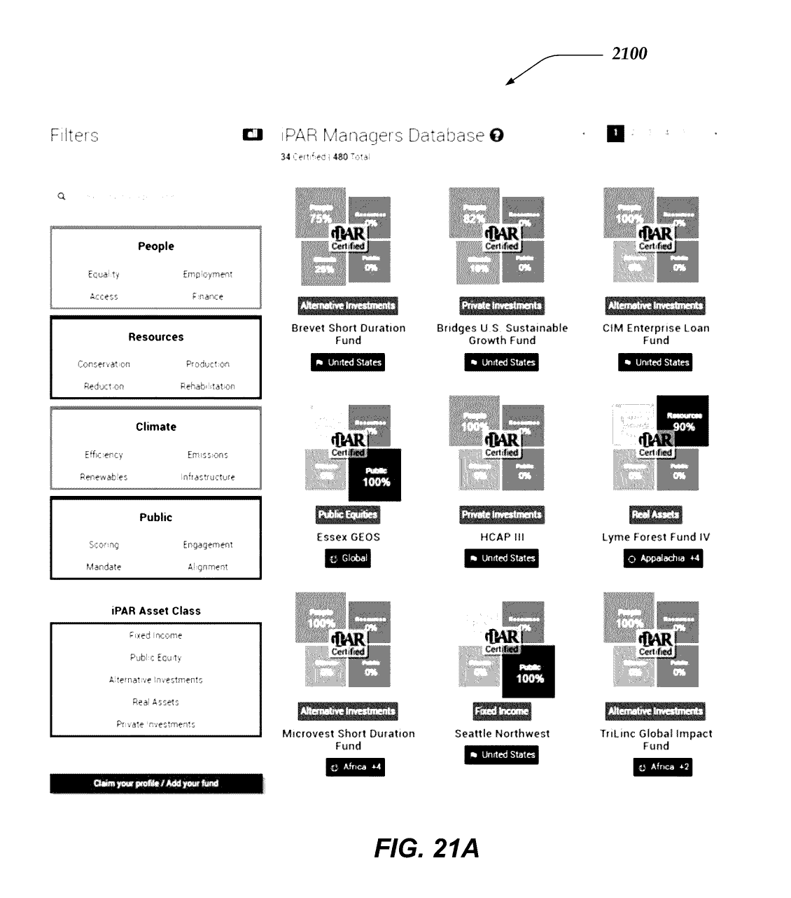

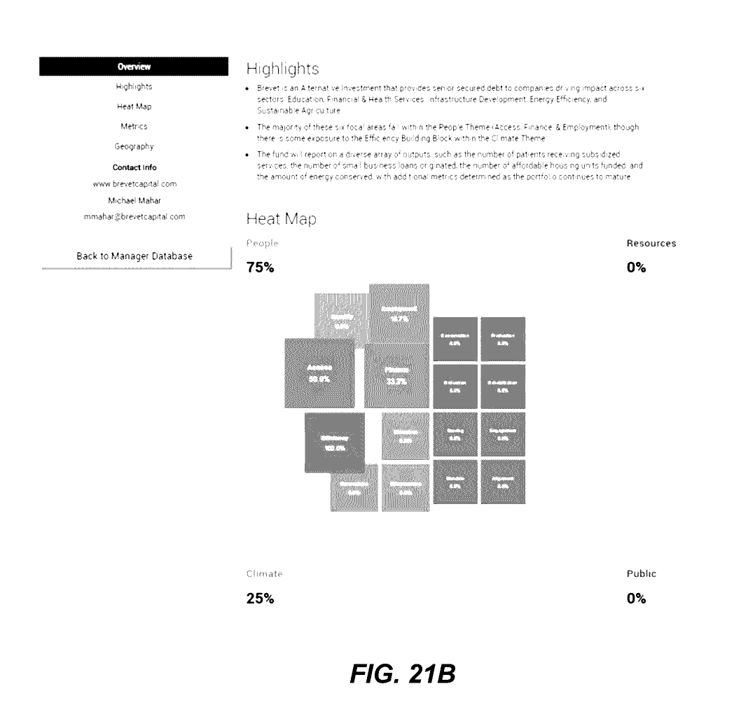

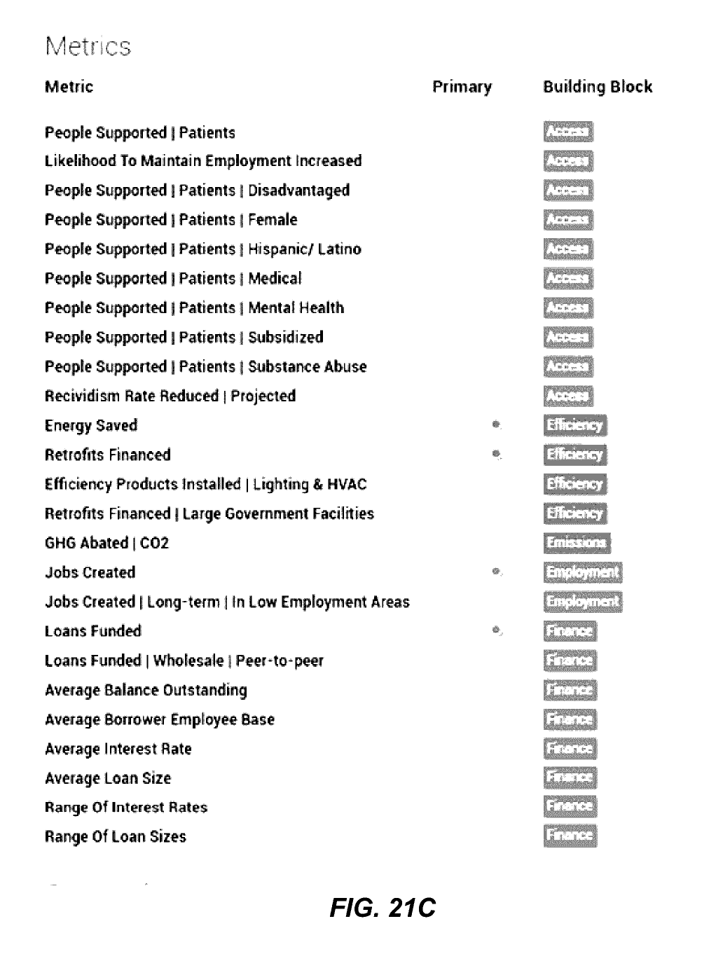

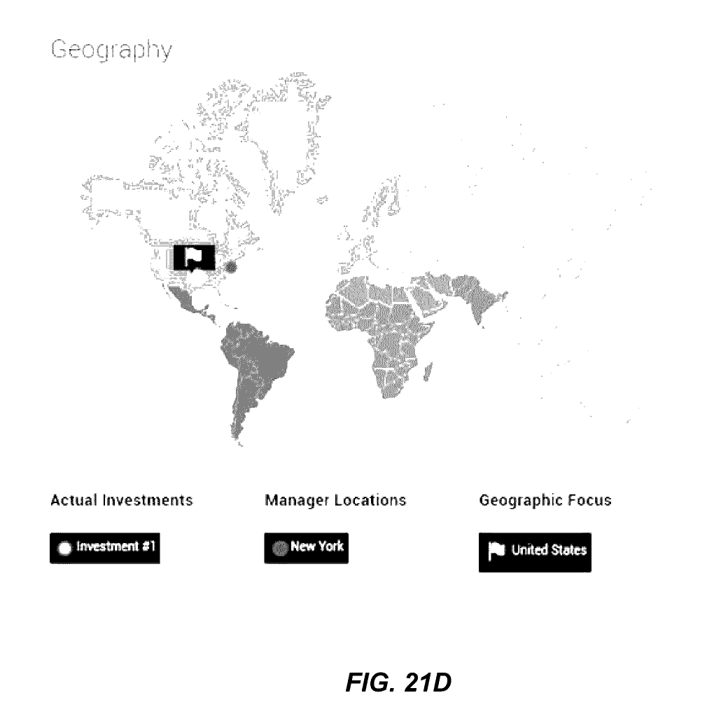

FIG. 21A shows a screen clipping of an interface that provides a portion of a fund manager database 2100 that is consistent with the various embodiments described herein. Fund manager database 2100 may include one or more entries for at least a portion of the particular fund managers tracked by and/or reporting to various embodiments of IPAR. As shown in FIG. 21A, a particular embodiment of IPAR is tracking a total of 480 fund managers, of which 34 are certified. FIG. 21A is showing an indication of 9 (each of which is certified) of the 480 fund managers. Each of the particular indications provides a visual representation of a heat map for the corresponding particular fund manager.

FIG. 21B shows a screen clipping of an interface that provides highlights and a heat map for a particular fund manager included in the fund manager database of FIG. 21A. FIG. 21C shows a screen clipping of an interface that provides metrics reported by the particular fund manager of FIG. 21B. FIG. 21D shows a screen clipping of an interface that provides geography information for the particular fund manager of FIG. 21B. The screen clippings for FIGS. 21B-21D may be provided to a user by selecting the particular indication for the particular fund manager in the fund manager database 2100 of FIG. 21A. By selecting a particular fund manager, the user may be provided information included in an entry for the particular fund manager included in the fund manager database. At least a portion of the information included in a particular entry in the fund manager database may be at least partially provided by the corresponding particular fund manager. As shown in FIGS. 21B-21D, such information may include, highlights, a detailed heat map (themes and building blocks), at least a partial listing of the metrics reported by the particular fund manager (with the associated building block), and a geography map providing a visual indication of the locations of where the fund may be providing impacts.

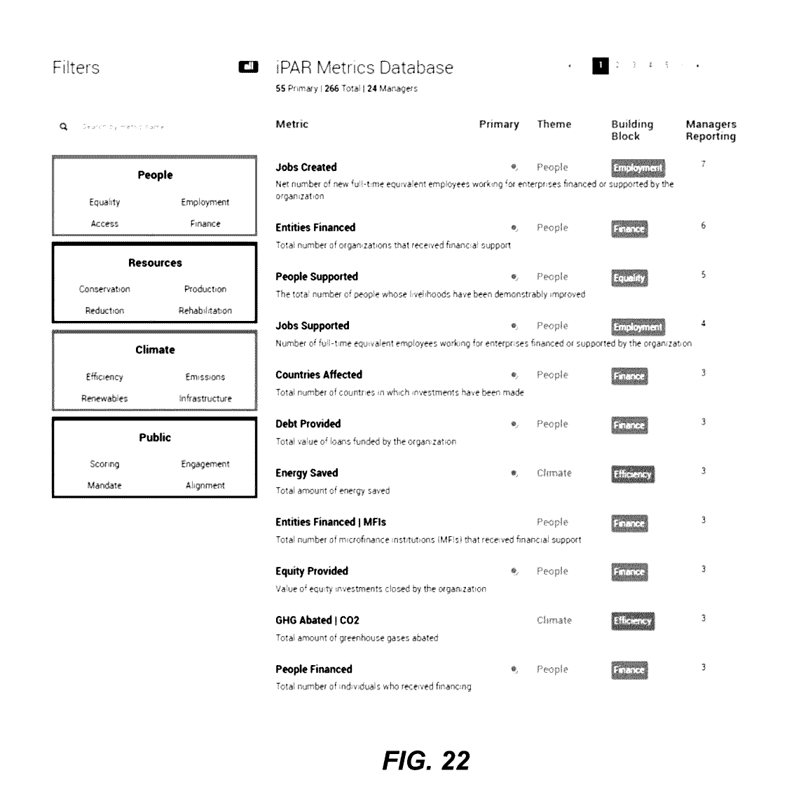

FIG. 22 shows a screen clipping of an interface that provides a metrics database that is consistent with the various embodiments described herein. In addition to a fund manager database, various embodiments of IPAR may include a metric database. Such a metric database may include one or more entries for at least a portion of the metrics tracked by IPAR. FIG. 22 shows that particular embodiment of IPAR is currently tracking a total of 266 metrics, including 55 primary metrics. FIG. 22 provides a listing of 11 of the 266 metrics. To access the database entry for a particular metric, a user may select the particular metric. The listing of FIG. 22 shows which of the metrics are primary metrics, as well as the corresponding theme and building block for each metric. The listing also shows the number of fund managers that are reporting foe each metric.

It will be understood that each block of the flowchart the illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowcharts to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Additionally, in one or more steps or blocks, may be implemented using embedded logic hardware, such as, an Application Specific Integrated Circuit (ASIC), Field Programmable Gate Array (FPGA), Programmable Array Logic (PAL), or the like, or combination thereof, instead of a computer program. The embedded logic hardware may directly execute embedded logic to perform actions some or all of the actions in the one or more steps or blocks. Also, in one or more embodiments (not shown in the figures), some or all of the actions of one or more of the steps or blocks may be performed by a hardware microcontroller instead of a CPU. In at least one embodiment, the microcontroller may directly execute its own embedded logic to perform actions and access its own internal memory and its own external Input and Output Interfaces (e.g., hardware pins and/or wireless transceivers) to perform actions, such as System On a Chip (SOC), or the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for managing a resource with a network computer that includes one or more processors that perform actions, comprising:
employing one or more resource management engines that perform actions, including:
providing one or more portfolio data structures for the resource based on one or more impact strategies for the resource, wherein the one or more portfolio data structures include records that are self-referential;
providing building block distribution data for the resource based on the one or more portfolio data structures for the resource;
providing a resource impact strategy score based on the building block distribution data and one or more impact factor ratings for the resource;
providing a resource execution risk score based on the one or more building block distribution data and one or more risk ratings for the resource;
providing one or more impact milestones for the resource based on an impact performance of the resource;
updating the resource execution risk score based on the one or more impact milestones of the resource;
providing one or more resource impact performance reports for the resource that include at least one of the resource impact strategy score, one or more impact milestones, or the resource execution risk score; and
storing the one or more resource management impact performance reports in a non-transitory storage memory.

2. The method of claim 1, wherein the actions performed by the one or more resource management engines further include:
providing one or more impact metrics for the resource based on the one or more impact strategies of the resource and one or more impact taxonomies; and
storing the one or more impact metrics in the non-transitory storage memory.

3. The method of claim 1, wherein the building block distribution data includes one or more of an Equality component, an Employment component, an Access component, or a Finance component.

4. The method of claim 1, wherein the actions performed by the one or more resource management engines further include:
providing sub-building block data associated with one or more components of the one or more building block distribution data based on the one or more impact strategies of the resource.

5. The method of claim 1, wherein the actions performed by the one or more resource management engines further include:
providing one or more Target impact factor ratings for the resource;
providing one or more Scalability impact factor ratings for the resource;
providing one or more Innovation impact factor ratings for the resource; and
providing the resource impact strategy score further based on one or more of the Target impact factor ratings, Scalability impact factor ratings, or Innovation impact factor ratings.

6. The method of claim 1, wherein the actions performed by the one or more resource management engines further include:
providing the one or more risk ratings for the resource based on one or more risks associated with one or more components of the one or more impact theme distribution data for the resource.

7. The method of claim 1, wherein the actions performed by the one or more resource management engines further include:
providing one or more weights for each component of the one or more impact theme distribution data for the resource based on at least an impact thesis; and
providing at least one of the resource impact strategy score or the resource execution risk score further based on the one or more weights.

8. The method of claim 1, wherein the actions performed by the one or more resource management engines further include:
providing one or more firm scores for the resource based on results of a questionnaire; and
storing the one or more firm scores in the storage media.

9. A system arranged for managing a resource over a network, comprising:
a transceiver that communicates over the network;
a memory that stores at least instructions; and
one or more processor devices that execute the instructions that execute one or more resource management engines that perform actions, comprising:
providing one or more portfolio data structures for the resource based on one or more impact strategies for the resource, wherein the one or more portfolio data structures include records that are self-referential;
providing building block distribution data for the resource based on the one or more portfolio data structures for the resource;
providing a resource impact strategy score based on the building block distribution data and one or more impact factor ratings for the resource;
providing a resource execution risk score based on the one or more building block distribution data and one or more risk ratings for the resource;
providing one or more impact milestones for the resource based on an impact performance of the resource;
updating the resource execution risk score based on the one or more impact milestones of the resource;
providing one or more resource impact performance reports for the resource that include at least one of the resource impact strategy score, one or more impact milestones, or the resource execution risk score; and
storing the one or more resource management impact performance reports in a non-transitory storage memory.

10. The system of claim 9, wherein the actions performed by the one or more resource management engines further include:
providing one or more impact metrics for the resource based on the one or more impact strategies of the resource and one or more impact taxonomies; and
storing the one or more impact metrics in the non-transitory storage memory.

11. The system of claim 9, wherein the building block distribution data includes one or more of an Equality component, an Employment component, an Access component, or a Finance component.

12. The system of claim 9, wherein the actions performed by the one or more resource management engines further include:
providing sub-building block data associated with one or more components of the one or more building block distribution data based on the one or more impact strategies of the resource.

13. The system of claim 9, wherein the actions performed by the one or more resource management engines further include:
providing one or more Target impact factor ratings for the resource;
providing one or more Scalability impact factor ratings for the resource;
providing one or more Innovation impact factor ratings for the resource; and
providing the resource impact strategy score further based on one or more of the Target impact factor ratings, Scalability impact factor ratings, or Innovation impact factor ratings.

14. The system of claim 9, wherein the actions performed by the one or more resource management engines further include:
providing the one or more risk ratings for the resource based on one or more risks associated with one or more components of the one or more impact theme distribution data for the resource.

15. The system of claim 9, wherein the actions performed by the one or more resource management engines further include:
providing one or more weights for each component of the one or more impact theme distribution data for the resource based on at least an impact thesis; and
providing at least one of the resource impact strategy score or the resource execution risk score further based on the one or more weights.

16. The system of claim 9, wherein the actions further include:
providing one or more firm scores for the resource based on results of a questionnaire; and
storing the one or more firm scores in at memory.

17. A processor readable non-transitory storage media that includes instructions for managing a resource with a network computer, wherein one or more processors execute the instructions that perform actions, comprising:
employing one or more resource management engines that perform actions, including:
providing one or more portfolio data structures for the resource based on one or more impact strategies for the resource, wherein the one or more portfolio data structures include records that are self-referential;
providing building block distribution data for the resource based on the one or more portfolio data structures for the resource;
providing a resource impact strategy score based on the building block distribution data and one or more impact factor ratings for the resource;
providing a resource execution risk score based on the one or more building block distribution data and one or more risk ratings for the resource;
providing one or more impact milestones for the resource based on an impact performance of the resource;
updating the resource execution risk score based on the one or more impact milestones of the resource;
providing one or more resource impact performance reports for the resource that include at least one of the resource impact strategy score, one or more impact milestones, or the resource execution risk score; and
storing the one or more resource management impact performance reports in a non-transitory storage memory.

18. The media of claim 17, wherein the actions performed by the one or more resource management engines further include:
providing one or more impact metrics for the resource based on the one or more impact strategies of the resource and one or more impact taxonomies; and
storing the one or more impact metrics in the non-transitory storage memory.

19. The media of claim 17, wherein the building block distribution data includes one or more of an Equality component, an Employment component, an Access component, or a Finance component.

20. The media of claim 17, wherein the actions performed by the one or more resource management engines further include:
providing sub-building block data associated with one or more components of the one or more building block distribution data based on the one or more impact strategies of the resource.

21. The media of claim 17, wherein the actions performed by the one or more resource management engines further include:
providing one or more Target impact factor ratings for the resource;
providing one or more Scalability impact factor ratings for the resource;
providing one or more Innovation impact factor ratings for the resource; and
providing the resource impact strategy score further based on one or more of the Target impact factor ratings, Scalability impact factor ratings, or Innovation impact factor ratings.

22. The media of claim 17, wherein the actions performed by the one or more resource management engines further include:
providing the one or more risk ratings for the resource based on one or more risks associated with one or more components of the one or more impact theme distribution data for the resource.

23. The media of claim 17, wherein the actions performed by the one or more resource management engines further include:
providing one or more weights for each component of the one or more impact theme distribution data for the resource based on at least an impact thesis; and
providing at least one of the resource impact strategy score or the resource execution risk score further based on the one or more weights.

24. The media of claim 17, wherein the actions performed by the one or more resource management engines further include:
providing one or more firm scores for the resource based on results of a questionnaire; and storing the one or more firm scores in the other storage media.
